(19) United States
(12) Patent Application Publication
(10) Pub. No.: US 2009/0156359 A1
(43) Pub. Date: Jun. 18, 2009

(54) Power transmission apparatus for vehicle

(75) Inventors: Atsushi Tabata, Okazaki-shi (JP); Kenta Kumazaki, Toyota-shi (JP); Tooru Matsubara, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/314,318

(22) Filed: Dec. 8, 2008

(30) Foreign Application Priority Data
Dec. 14, 2007 (JP) 2007-323403

(51) Int. Cl. F16H 61/04

(52) U.S. Cl. 477/108

(57) ABSTRACT

A power transmission apparatus for a vehicle includes a main drive power source; a first shift unit that has an input shaft connected to the main drive power source; a second shift unit; at least one electric motor connected to a rotating element of the first shift unit or a rotating element of the second shift unit so that the rotational speed of the electric motor is changed in accordance with a gear-shift of the first shift unit or the second shift unit, and that is able to control the rotational speed of the main drive power source by changing its rotation; and a control unit that executes control so that the direction in which the rotational speed of the main drive power source is changed is maintained constant throughout a gear-shift, when the gear-shift is a simultaneous gear-shift in which the gear-shift of the first shift unit and the gear-shift of the second shift unit are performed simultaneously and a gear ratio of the first shift unit and a gear ratio of the second shift unit are changed in opposite directions. With the control executed by the control unit, it is possible to effectively suppress occurrence of shift shock.

### INCORPORATION BY REFERENCE

The disclosure of Japanese Patent Application No. 2007-323403 filed on Dec. 14, 2007 including the specification, drawings and abstract is incorporated herein by reference in its entirety.

### BACKGROUND OF THE INVENTION

1. Field of the Invention

The invention relates generally to a power transmission apparatus for a vehicle, which includes a main drive power source, a first shift unit that has an input shaft connected to the main drive power source, a second shift unit, at least one electric motor that is connected to a rotating element of the first shift unit or a rotating element of the second shift unit so that the rotational speed of the electric motor changes in accordance with a gear-shift of the first shift unit or a gear-shift of the second shift unit, and a control unit. More specifically, the invention relates to refinements in the technology for suppressing occurrence of shift shock.

2. Description of the Related Art

There is a power transmission apparatus for a vehicle, which includes a main drive power source, a first shift unit that has an input shaft connected to the main drive power source, a second shift unit, and at least one electric motor that is connected to a rotating element of the first shift unit or a rotating element of the second shift unit so that the rotational speed of the electric motor changes in accordance with a gear-shift of the first shift unit or a gear-shift of the second shift unit. Examples of such power transmission apparatus for a vehicle include an automatic transmission described in Japanese Patent Application Publication No. 2007-1389 (JP-A-2007-1389). The automatic transmission according to JP-A-2007-1389 includes a first shift unit and a second shift unit that are arranged in tandem with each other. The first shift unit may operate as an electric continuously variable shift unit and a second shift unit selects one of multiple gears. The first shift unit may be switched between the continuously variable shift mode in which the first shift unit functions as an electric continuously variable shift unit and the stepped shift mode in which the first shift unit does not function as a continuously variable shift unit. The gear ratio of the first shift unit and the gear ratio of the second shift unit may be individually controlled.

Performing the gear-shift of the first shift unit and the gear-shift of the second shift unit at the same time, that is, performing a simultaneous gear-shift of the first shift unit and the second shift unit, is not described in related art documents, for example, JP-A-2007-1389. In addition, the related art documents do not describe the fact that the direction in which the gears of the first shift unit are shifted and the direction in which the gears of the second shift unit are shifted may be opposite to each other when the gear-shift of the first shift unit and the gear-shift of the second shift unit are performed at the same time. The inventors et al. have continued with their studies to bring the simultaneous gear-shift of the first shift unit and the second shift unit into active use. In the process of their studies, the following inconvenience was found. That is, when such simultaneous gear-shift is performed according to the related art, if the direction in which the gear ratio of the first shift unit is changed and the direction in which the gear ratio of the second shift unit is changed are opposite to each other and the timing of the gear-shift of the first shift unit and the timing of the gear-shift of the second shift unit are slightly off, the engine speed fluctuates. Such fluctuations may give a sense of discomfort to occupants.

### SUMMARY OF THE INVENTION

The invention is made in light of the above-described circumstances. The invention provides a power transmission apparatus for a vehicle with which occurrence of shift shock is effectively suppressed.

An aspect of the invention relates to a power transmission apparatus for a vehicle that includes: a main drive power source; a first shift unit that has an input shaft connected to the main drive power source; a second shift unit; at least one electric motor that is connected to a rotating element of the first shift unit or a rotating element of the second shift unit so that the rotational speed of the electric motor is changed in accordance with a gear-shift of the first shift unit or a gear-shift of the second shift unit, and that controls the rotational speed of the main drive power source by changing rotation of the electric motor; and a control unit that executes control so that the direction in which the rotational speed of the main drive power source is changed is maintained constant throughout a gear-shift, when the gear-shift is a simultaneous gear-shift in which the gear-shift of the first shift unit and the gear-shift of the second shift unit are performed simultaneously and a gear ratio of the first shift unit and a gear ratio of the second shift unit are changed in opposite directions.

In the power transmission apparatus described above, the electric motor is able to control the rotational speed of the main drive power source by changing its rotation, and the control unit executes the control so that the direction in which the rotational speed of the main drive power source is changed is maintained constant throughout a gear-shift, when the gear-shift is a simultaneous gear-shift in which the gear-shift of the first shift unit and the gear-shift of the second shift unit are performed simultaneously and a gear ratio of the first shift unit and a gear ratio of the second shift unit are changed in opposite directions. Therefore, it is possible to prevent fluctuations of the rotational speed of the main drive power source, thereby shifting gears smoothly. That is, it is possible to provide the power transmission apparatus for a vehicle, with which occurrence of shift shock is effectively suppressed.

In the power transmission apparatus described above, the control unit may control the rotation of the electric motor based on a change in the speed of rotation input in the second shift unit according to a predetermined relationship. In this way, it is possible to prevent fluctuations of the rotational speed of the main drive power source with the use of the electric motor in a practical manner.

In the power transmission apparatus described above, the first shift unit may have a planetary gear unit that includes a first rotating element connected to the main drive power source, a second rotating element connected to the electric motor, and a third rotating element connected to an input member of the second shift unit. With this structure, it is possible to effectively suppress shift shock in the simultaneous gear shift of the first shift unit and the second shift unit, in the power transmission apparatus that includes the first shift unit which has a practical configuration.

### BRIEF DESCRIPTION OF THE DRAWINGS

The features, advantages and technical and industrial significance of this invention will be described in the following detailed description of example embodiments of the invention with reference to the accompanying drawings, wherein the same or corresponding portions will be denoted by the same reference numerals and wherein:

FIG. 1 is a view schematically showing the structure of a power transmission apparatus for a vehicle according to a first embodiment of the invention;

FIG. 2 is an operation chart showing the relationship between shift operations, which are performed when a transmission of the power transmission apparatus in FIG. 1 is made to shift gears in a stepped manner, and the combinations of hydraulic friction application devices that are applied when the shift operations are performed;

FIG. 3 is a collinear diagram illustrating the relative rotational speed in each gear when the transmission of the power transmission apparatus in FIG. 1 is made to shift gears in a stepped manner;

FIG. 4 is a diagram showing signals input in/output from an electronic control unit provided in the power transmission apparatus in FIG. 1;

FIG. 5 is a functional block diagram illustrating the main portions of control operations executed by the electronic control unit shown in FIG. 4;

FIG. 6 is a graph showing examples of a shift diagram which is stored in advance and used to determine whether gears should be changed, a switching diagram which is stored in advance and used to determine whether the shift mode of the transmission should be changed, and a drive power source switching diagram which is stored in advance, which includes a boundary line between an engine-power cruise range and a motor-power cruise range, and which is used to determine whether the drive power source should be changed, all of the diagrams being formed on the same two-dimensional coordinate system that uses the vehicle speed and the output torque as parameters;

FIG. 7 is a view showing an example of a shift operation device that includes a shift lever and that is operated to select one of multiple shift positions;

FIG. 8 is a flowchart showing the main portion of a shift control routine executed by the electronic control unit in FIG. 4;

FIG. 9 is a time chart showing the operation of each unit in accordance with the control shown in FIG. 8;

FIG. 10 is a view schematically showing a power transmission apparatus for a vehicle according to a second embodiment of the invention;

FIG. 11 is an operation chart showing the relationship between shift operations, which are performed when a transmission of the power transmission apparatus in FIG. 10 is made to shift gears in a stepped manner, and the combinations of hydraulic friction application devices that are applied when the shift operations are performed; and

FIG. 12 is a collinear diagram illustrating the relative rotational speed in each gear when the transmission of the power transmission apparatus in FIG. 10 is made to shift gears in a stepped manner.

### DETAILED DESCRIPTION OF THE EMBODIMENTS

Example embodiments of the invention will be described in greater detail below with reference to the accompanying drawings. First, a first embodiment of the invention will be described in detail with reference to the accompanying drawings.

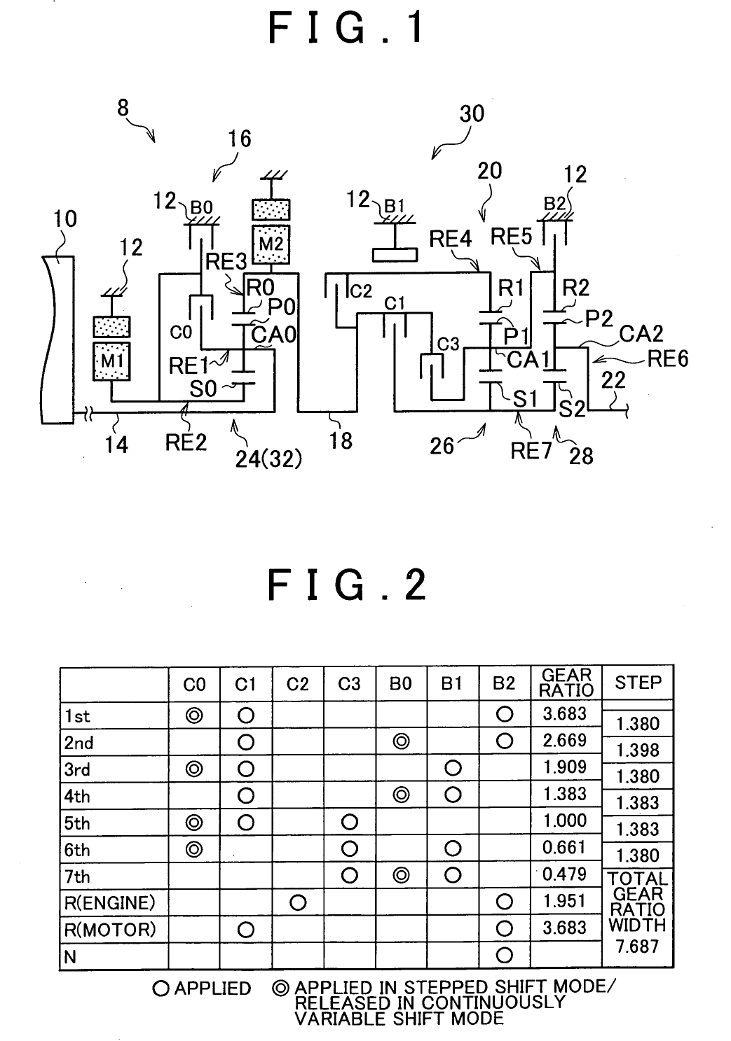

FIG. 1 is a view schematically showing the structure of a power transmission apparatus 8 for a vehicle that constitutes part of a drive system of a hybrid vehicle according to a first embodiment of the invention. As shown FIG. 1, the power transmission apparatus 8 includes an input shaft 14, a first shift unit 16, a second shift unit 20, and an output shaft 22, all of which are coaxially arranged in tandem inside a transmission case 12 (hereinafter, simply referred to as “case 12”) which is a non-rotating member that is attached to a vehicle body. The input shaft 14 serves as an input rotating member that is either directly connected to an engine 10, which is a main drive power source, or connected to the engine 10 via a pulsation absorbing damper (vibration damping device), not shown. The first shift unit 16 is connected to the input shaft 14, and functions as a differential unit or a continuously variable shift unit. The second shift unit 20 functions as a stepped shift unit. The second shift unit 20 is arranged on a power transmission path between the first shift unit 16 and a pair of drive wheels 38 (see FIG. 5), and is connected to the first shift unit 16 via a transmitting member (transmitting shaft) 18. The output shaft 22 is an output rotating member that transmits the power from the second shift unit 20 to members arranged downstream of the second shift unit 20. In the first embodiment of the invention, the transmitting member 18 serves as an input member of the second shift unit 20. In the power transmission apparatus 8, the first shift unit 16 and the second shift unit 20, which are arranged in tandem, constitute a transmission 30. Because the length of the transmission 30 in its axial direction is relatively long, the power transmission apparatus 8 is used preferably in, for example, a FR (front-engine, rear-drive) vehicle in which an engine and a transmission are longitudinally disposed. The power transmission apparatus 8 is provided on a power transmission path between the engine 10 and the drive wheels 38. This power transmission apparatus 8 transmits the drive power from the engine 10 to the drive wheels 38 via, for example, a differential gear unit (final reduction device) 36 and a pair of axles, in this order, which constitute part of the power transmission path.

The engine 10 is a drive power source (main drive power source) that generates drive power used to drive the vehicle, and is formed of an internal combustion engine, for example, a gasoline engine or a diesel engine, or an external combustion engine. As shown in FIG. 1, in the power transmission apparatus 8 according to the first embodiment of the invention, the engine 10 and the first shift unit 16 are directly connected to each other. That is, the engine 10 is connected to the first shift unit 16 without provision of a fluid transmission device such as a torque converter or a fluid coupling between the engine 10 and the first shift unit 16. Therefore, for example, when the engine 10 is connected to the first shift unit 16 via, for example, the above-mentioned pulsation absorbing damper, it is regarded that the engine 10 is directly connected to the first shift unit 16. Because the configuration of the power transmission apparatus 8 is symmetric with respect to the axis thereof, the lower portion of the power transmission apparatus 8 is not shown in FIG. 1.

The first shift unit 16 includes a first electric motor M1, a power split mechanism 32, and a second electric motor M2. The first electric motor M1 is arranged in such a manner that a rotor thereof rotates together with a sun gear S0 of a planetary gear unit 24. The power split mechanism 32 is a mechanical mechanism that mechanically distributes the drive power that is input in the input shaft 14 from the engine 10, and is also a differential mechanism that distributes the drive power output from the engine 10 to the first electric motor M1 and the transmitting member 18. The second electric motor M2 is arranged in such a manner that a rotor thereof rotates together with the transmitting member 18. The second electric motor M2 may be provided at any portion in the power transmission path between the transmitting member 18 and the drive wheels 38.

The first electric motor M1 and the second electric motor M2 included in the power transmission apparatus 8 according to the first embodiment of the invention are both so-called motor-generators that function as the drive power sources which generate drive power and that also function as electric power generators. The first electric motor M1 is an electric motor that functions as at least a generator (is able to generate electric power) which generates a reaction force, and the second electric motor M2 is an electric motor that functions as at least a motor (is able to generate drive power) which outputs drive power. The second electric motor M2 serves as drive power source that generates the drive power used to drive the vehicle. Hereinafter, the first electric motor M1 and the second electric motor M2 will be collectively referred to as electric motors M when the first electric motor M1 and the second electric motor M2 need not be distinguished from each other.

The power split mechanism 32 mainly includes the single-pinion planetary gear unit 24 having a predetermined gear ratio ρ0 of, for example, approximately 0.380, a switching clutch C0, and a switching brake B0. The planetary gear unit 24 includes rotating elements, that is, the sun gear S0, pinions P0, a carrier CA0 which supports the pinions P0 in such a manner that the pinions P0 are allowed to rotate about their axes and turn around the sun gear S0, and a ring gear R0 that is in mesh with the sun gear S0 via the pinions P0. When the number of teeth on the sun gear S0 is ZS0 and the number of teeth on the ring gear R0 is ZR0, the gear ratio ρ0 is expressed as ZS0/ZR0.

In the power split mechanism 32, the carrier CA0 is connected to the engine 10 via the input shaft 14, the sun gear S0 is connected to the first electric motor M1, and the ring gear R0 is connected to the transmitting member 18. The switching brake B0 is provided between the sun gear S0 and the case 12, and the switching clutch C0 is provided between the sun gear S0 and the carrier CA0. Releasing both the switching clutch C0 and the switching brake B0 enables the three rotating elements of the planetary gear unit 24, that is, the sun gear S0, the carrier CA0, and the ring gear R0 to rotate relative to each other, thus placing the power split mechanism 32 in the differential mode in which the power split mechanism 32 performs differential operation. Therefore, the drive power output from the engine 10 is distributed to the first electric motor M1 and the transmitting member 18. Part of the drive power output from the engine 10, which is distributed to the first electric motor M1, is used to run the first electric motor M1 to generate electric power. The generated electric power is stored, or used to run the second electric motor M2. Accordingly, the first shift unit 16 (power split mechanism 32) is placed in the so-called continuously variable shift mode (electric CVT mode) and the rotational speed of the transmitting member 18 is continuously changed even when the engine 10 is operating at a constant speed. When the power split mechanism 32 is placed in the differential mode, the first shift unit 16 is placed in the continuously variable shift mode in which the first shift unit 16 functions as an electric continuously variable shift unit of which the gear ratio γ0 (rotational speed of the input shaft 14/rotational speed of the transmitting member 18) is continuously changed within a gear ratio range from the minimum value γ0ₘᵢₙ to the maximum value γ0ₘₐₓ.

Then, if the switching clutch C0 or the switching brake B0 is applied, the power split mechanism 32 is placed in the non-differential mode in which the power split mechanism 32 cannot perform the differential operation. More specific description will be provided below. When the switching clutch C0 is applied and therefore the sun gear S0 and the carrier CA0 are connected to each other, the power split mechanism 32 is placed in the connected mode, that is, the locked mode in which the three rotating elements of the planetary gear unit 24, that is, the sun gear S0, the carrier CA0, and the ring gear R0 are rotated together, in other words, the power split mechanism 32 is placed in the non-differential mode in which the power split mechanism 32 cannot perform the differential operation. As a result, the first shift unit 16 is also placed in the non-differential mode. Also, the rotational speed of the engine 10 matches the rotational speed of the transmitting member 18. Therefore, the first shift unit 16 (power split mechanism 32) is placed in the non-continuously variable shift mode, for example, the fixed shift mode, that is, the stepped shift mode, in which the first shift unit 16 functions as a shift unit of which the gear ratio γ0 is fixed at 1. When the switching brake B0 is applied instead of the switching clutch C0 and therefore the sun gear S0 is connected to the case 12, the power split mechanism 32 is placed in the non-differential mode in which the sun gear S0 is not allowed to rotate. As a result, the first shift unit 16 is also placed in the non-differential mode. The ring gear R0 rotates faster than the carrier CA0. Therefore, the power split mechanism 32 is placed in the non-continuously variable shift mode, for example, the fixed shift mode, that is, the stepped shift mode, in which power split mechanism 32 functions as a speed increasing shift unit of which the gear ratio γ0 is fixed at a value less than 1, for example, approximately 0.7.

As described above, the switching clutch C0 and the switching brake B0 function as differential mode switching devices that selectively switch the shift mode of the first shift unit 16 (power split mechanism 32) between the differential mode, i.e., the unlocked mode (non-connected mode), and the non-differential mode, i.e., the locked mode (connected mode). In the differential mode, the first shift unit 16 (power split mechanism 32) is placed in the differential mode in which the first shift unit 16 (power split mechanism 32) functions as an electric differential device, for example, the continuously variable shift mode in which the first shift unit 16 (power split mechanism 32) functions as an electric continuously variable shift unit of which the gear ratio is changed continuously. In the non-differential mode, the first shift unit 16 (power split mechanism 32) is placed in the non-continuously variable shift mode in which the first shift unit 16 (power split mechanism 32) does not perform the electric continuously variable shift operation, for example, the locked mode in which the gear ratio is fixed at a predetermined value, namely, the fixed shift mode (non-differential mode) in which the first shift unit 16 (power split mechanism 32) functions as a single-speed shift unit having one gear ratio or a multi-speed shift unit having multiple gear ratios (in the first embodiment of the invention, the first shift unit 16 (power split mechanism 32) functions as a two-speed shift unit). In other words, the switching clutch C0 and the switching brake B0 function as differential operation restriction devices that place the power split mechanism 32 in the non-differential mode to restrict the differential operation of the power split mechanism 32, thereby placing the first shift unit 16 in the non-continuously variable shift mode to restrict the operation of the first shift unit 16 as an electric differential device or a continuously variable shift unit.

The second shift unit 20 includes a single-pinion first planetary gear unit 26 and a single-pinion second planetary gear unit 28, and functions as a four-speed stepped automatic shift unit. The first planetary gear unit 26 includes a first sun gear S1, first pinions P1, a first carrier CA1 which supports the first pinions P1 in such a manner that the first pinions P1 are allowed to rotate about their axes and turn around the first sun gear S1, and a first ring gear R1 that is in mesh with the first sun gear S1 via the first pinions P1. The first planetary gear unit 26 has a predetermined gear ratio ρ1 of, for example, approximately 0.529. The second planetary gear unit 28 includes a second sun gear S2, second pinions P2, a second carrier CA2 which supports the second pinions P2 in such a manner that the second pinions P2 are allowed to rotate about their axes and turn around the second sun gear S2, and a second ring gear R2 that is in mesh with the second sun gear S2 via the second pinions P2. The second planetary gear unit 28 has a predetermined gear ratio ρ2 of, for example, approximately 0.372. When the number of teeth on the first sun gear S1 is ZS1, the number of the teeth on the first ring gear R1 is ZR1, the number of teeth on the second sun gear S2 is ZS2, and the number of teeth on the second ring gear R2 is ZR2, the gear ratio ρ1 is expressed as ZS1/ZR1, and the gear ratio ρ2 is expressed as ZS2/ZR2.

In the second shift unit 20, the first sun gear S1 and the second sun gear S2 are connected to each other, and selectively connected to the transmitting member 18 via a first clutch C1. Also, the first carrier CA1 and the second ring gear R2 are connected to each other, selectively connected to the case 12 via a second brake B2, and selectively connected to the transmitting member 18 via a third clutch C3. The first ring gear R1 is selectively connected to the case 12 via a first brake B1, and selectively connected to the transmitting member 18 via a second clutch C2. The second carrier CA2 is connected to the output shaft 22. In this way, the second shift unit 20 and the transmitting member 18 are selectively connected to each other via one of the first clutch C1, the second clutch C2 and the third clutch C3 which are used to select the gear of the second shift unit 20. In other words, the first clutch C1, the second clutch C2 and the third clutch C3 are input clutches for the second shift unit 20, and function as application devices that change the state of the power transmission path which extends between the transmitting member 18 and the second shift unit 20, i.e., which extends between the first shift unit 16 (transmitting member 18) and the drive wheels 38. The state of the power transmission path is changed between the power transmittable state in which the drive power is allowed to be transmitted along that power transmission path and the power transmission-interrupted state in which transmission of the drive power along that power transmission path is interrupted. That is, applying at least one of the first clutch C1, the second clutch C2 and the third clutch C3 places the power transmission path in the power transmittable state. Conversely, releasing all the first clutch C1, the second clutch C2, and the third clutch C3 places the power transmission path in the power transmission-interrupted state.

The switching clutch C0, the first clutch C1, the second clutch C2, the third clutch C3 (hereinafter, these clutches will be collectively referred to as “clutches C” when they need not be distinguished from each other), the switching brake B0, the first brake B1, and the second brake B2 (hereinafter, these brakes will be collectively referred to as “brakes B” when they need not be distinguished from each other) are hydraulic friction application devices that are used in existing automatic transmissions for a vehicle. The clutches C may be wet multiple-disc clutches in which a plurality of stacked friction plates are pressed together by a hydraulic actuator, and the brakes B may be band brakes in which one end of one or two bands that are wound around the outer peripheral surface of a rotating drum is pulled tight by a hydraulic actuator. Each hydraulic friction application device selectively connects members, located on both sides of the hydraulic friction application device, to each other.

In the power transmission apparatus 8 structured as described above, the first shift unit 16, which is placed in the fixed shift mode by applying one of the switching clutch C0 and the switching brake B0, and the second shift unit 20, which is a stepped shift unit, place the transmission 30 in the stepped shift mode. On the other hand, the first shift unit 16, which is placed in the continuously variable shift mode by releasing both the switching clutch C0 and the switching brake B0, and the second shift unit 20, which is a stepped shift unit, place the transmission 30 in the continuously variable shift mode in which the transmission 30 functions as an electric continuously variable transmission.

When the first shift unit 16 is placed in the non-continuously variable shift mode and the transmission 30 functions as a stepped transmission, one of the switching clutch C0 and the switching brake B0 is applied, and the first clutch C1, the second clutch C2, the third clutch C3, the first brake B1, and the second brake B2 are selectively applied based on the combinations shown in the operation chart in FIG. 2. As a result, one of forward gears from first gear through seventh gear, reverse gear, and neutral is selected by the transmission 30 as a whole. Thus, the total gear ratio γT (=rotational speed N_{IN} of the input shaft 14/rotational speed N_{OUT} of the output shaft 22) of the transmission 30 at each gear is achieved. As shown in FIG. 2, the ratios between the total gear ratios γ of the adjacent gears are substantially equal to each other. In addition, the total gear ratio width (gear ratio γT1 of first gear/gear ratio γT7 of seventh gear) is wide. The total gear ratio γT of the transmission 30 is a gear ratio γT that is achieved by the transmission 30 as a whole based on the gear ratio γ0 of the first shift unit 16 and the gear ratio γA of the second shift unit 20.

As shown in the operation chart in FIG. 2, in the transmission 30, one of the following gears is selected. First gear having the maximum gear ratio γT1 of, for example, approximately 3.683 is selected by applying the switching clutch C0, the first clutch C1, and the second brake B2. Second gear having the gear ratio γT2 of, for example, approximately 2.669 which is smaller than the gear ratio γT1 of first gear is selected by applying the switching brake B0, the first clutch C1 and the second brake B2. Third gear having the gear ratio γT3 of, for example, approximately 1.909 which is smaller than the gear ratio γT2 of second gear is selected by applying the switching clutch C0, the first clutch C1 and the first brake B1. Fourth gear having the gear ratio γT4 of, for example, approximately 1.383 which is smaller than the gear ratio γT3 of third gear is selected by applying the switching brake B0, the first clutch C1 and the first brake B1. Fifth gear having the gear ratio γT5 of, for example, approximately 1.000 which is smaller than the gear ratio γT4 of fourth gear is selected by applying the switching clutch C0, the first clutch C1 and the third clutch C3. Sixth gear having the gear ratio γT6 of, for example, approximately 0.661 which is smaller than the gear ratio γT5 of fifth gear is selected by applying the switching clutch C0, the third clutch C3 and the first brake B1. Seventh gear having the gear ratio γT7 of, for example, approximately 0.479 which is smaller than the gear ratio γT6 of sixth gear is selected by applying the switching brake B0, the third clutch C3 and the first brake B1. Reverse gear for engine-power cruise having the gear ratio γR of, for example, approximately 1.951 which is a value between the gear ratio γT2 of second gear and the gear ratio γT3 of third gear is selected by applying the second clutch C2 and the second brake B2. Reverse gear for motor-power cruise having the gear ratio γR of, for example, approximately 3.683 which is equal to the gear ratio γT1 of first gear is selected by applying the first clutch C1, and the second brake B2. The reverse gear is usually selected when the first shift unit 16 is in the continuously variable shift mode. Neutral is selected by applying only the brake B2.

As is clear from the above-description and FIG. 2, in the transmission 30 according to the first embodiment of the invention, two-speed gear-shift of the first shift unit 16 and four-speed gear-shift of the second shift unit 20 are combined together to perform forward seven-speed gear-shift. The first shift unit 16 performs two-speed gear-shift by performing clutch-to-clutch gear-shift, that is, releasing one of the switching clutch C0 and the switching brake B0 and applying the other of the switching clutch C0 and the switching brake B0. The second shift unit 20 performs four-speed gear-shift by performing a clutch-to-clutch gear-shift, that is, releasing one of the first clutch C1, the second clutch C2, the third clutch C3, the first brake B1, and the second brake B2 and applying another one of the first clutch C1, the second clutch C2, the third clutch C3, the first brake B1 and the second brake B2. That is, the gear is shifted between first gear and second gear, between second gear and third gear, between third gear and fourth gear, between fourth gear and fifth gear, or between sixth gear and seventh gear by performing the gear-shift of the first shift unit 16 and the gear-shift of the second shift unit 20 at the same time within the same gear-shift period. The gear is shifted between fifth gear and sixth gear by a clutch-to-clutch gear-shift of the second shift unit 20.

In the simultaneous gear-shift in which the gear-shift of the first shift unit 16 (one of the switching clutch C0 and the switching brake B0 is released and the other of the switching clutch C0 and the switching brake B0 is applied) and the gear-shift of the second shift unit 20 are performed at the same time, the gear ratio γ0 of the first shift unit 16 is changed by the clutch-to-clutch gear-shift of the first shift unit 16, and the gear ratio γA of the second shift unit 20 is changed by the clutch-to-clutch gear-shift of the second shift unit 20. Under conventional control, the gear-shift of the first shift unit 16 may change an engine speed NE in one direction and the gear-shift of the second shift unit 20 may change the engine speed NE in the direction opposite to the direction in which the engine speed NE is changed by the gear-shift of the first shift unit 16. More specifically, for example, the engine speed NE may be decreased by the gear-shift of the first shift unit 16 and, at the same time, the engine speed NE is increased by the gear-shift of the second shift unit 20. Similarly, in the simultaneous switching operation in which switching of the shift mode of the first shift unit 16 between the continuously variable shift mode and the stepped shift mode and the gear-shift of the second shift unit 20 take place at the same time, the gear ratio γ0 of the first shift unit 16 is changed by switching the shift mode of the first shift unit 16 from the continuously variable shift mode to the stepped shift mode, and the gear ratio γA of the second shift unit 20 is changed by the clutch-to-clutch gear-shift of the second shift unit 20. Under the conventional control, switching of the shift mode of the first shift unit 16 may change the engine speed NE in one direction and the gear-shift of the second shift unit 20 may change the engine speed NE in the direction opposite to the direction in which the engine speed NE is changed by switching the shift mode of the first shift unit 16. For example, the engine speed NE is decreased by switching the shift mode of the first shift unit 16 and, at the same time, the engine speed NE is increased by the gear-shift of the second shift unit 20. Because the gear ratio γ0 of the first shift unit 16 is changed by switching the shift mode of the first shift unit 16 from the continuously variable shift mode to the stepped shift mode, the shift control in which switching of the shift mode of the first shift unit 16 from the continuously variable shift mode to the stepped shift mode and the gear-shift of the second shift unit 20 take place at the same time may be regarded as the simultaneous gear-shift in which the gear ratio of the first shift unit 16 and the gear ratio of the second shift unit 20 are changed at the same time.

However, when the transmission 30 is made to function as a continuously variable transmission by placing the first shift unit 16 in the continuously variable shift mode, both the switching clutch C0 and the switching brake B0 are released. As a result, the first shift unit 16 functions as a continuously variable shift unit. The second shift unit 20 that is connected in tandem with the first shift unit 16 functions as a forward four-speed stepped shift unit. Thus, the speed of rotation input in the second shift unit 20, that is, the rotational speed of the transmitting member 18 is continuously changed so that the total gear ratio γT is continuously changed although the gear ratio γA of the second shift unit 20 is changed in a stepped manner by automatically selecting a gear from among the forward four gears of the second shift unit 20. As a result, the gear ratio may be continuously changed at the gear M. As a result, the total gear ratio γT, which is achieved by the transmission 30 as a whole, is continuously changed. Thus, when the transmission 30 functions as a continuously variable transmission, both the switching clutch C0 and the switching brake B0 are released and the gear ratio γ0 of the first shift unit 16 is controlled so that the total gear ratio γT is continuously changed although the gear of the second shift unit 20 is selected from first gear of the second shift unit 20, second gear of the second shift unit 20, third gear of the second shift unit 20 and fourth gear of the second shift unit 20 in a stepped manner. As a result, the total gear ratio γT of the transmission 30 as a whole is continuously changed.

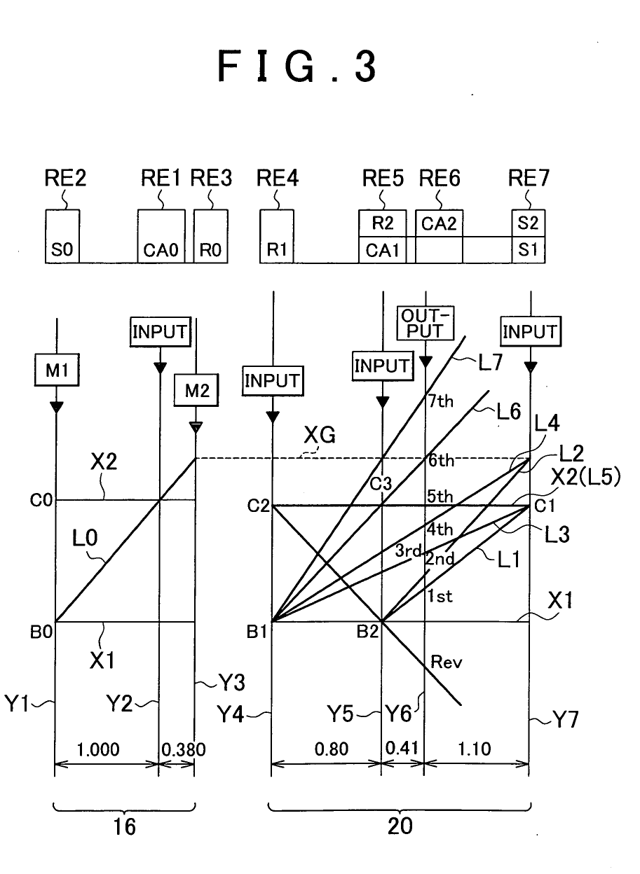

FIG. 3 is a collinear diagram that shows, using straight lines, the correlative relationships among the rotational speeds of the various rotating elements of the transmission 30 that is formed of the first shift unit 16, which functions as a continuously variable shift unit or a differential unit, and the second shift unit 20, which functions as a stepped automatic shift unit. The connection states of the rotating elements vary depending on the selected gear. The collinear diagram in FIG. 3 is a two-dimension coordinate system in which the abscissa axis represents the relationship of the gear ratios ρ of the planetary gear units 24, 26, and 28, and ordinate axis represents the relative rotational speeds. Among three horizontal lines, a lower horizontal line X1 represents a rotational speed of zero, an upper horizontal line X2 represents a rotational speed of 1.0, i.e., the rotational speed NE of the engine 10 that is connected to the input shaft 14, and a horizontal dot line XG represents the rotational speed of the transmitting member 18.

Also, three vertical lines Y1, Y2, and Y3 which correspond to the three elements of the power split mechanism 32 that forms the first shift unit 16 represent, in order from left to right, the relative rotational speeds of the sun gear S0 that is regarded as a second rotating element RE2, the carrier CA1 that is regarded as a first rotating element RE1, and the ring gear R0 that is regarded as a third rotating element RE3. The interval between the vertical lines Y1 and Y2, and the interval between the vertical lines Y2 and Y3 are determined based on the gear ratio ρ0 of the planetary gear unit 24. Further, four vertical lines Y4, Y5, Y6, and Y7 for the second shift unit 20 represent, in order from left to right, the relative rotational speeds of the first ring gear R1 which is regarded as a fourth rotating element RE4, the first carrier CA1 and the second ring gear R2 which are connected to each other and which are regarded as a fifth rotating element RE5, the second carrier CA2 which is regarded as a sixth rotating element RE6, and the first sun gear S1 and the second sun gear S2 which are connected to each other and which are regarded as a seventh rotating element RE7. The interval between the vertical lines Y4 and Y5, the interval between the vertical lines Y5 and Y6, and the interval between the vertical lines Y6 and Y7 are determined based on the gear ratio ρ2 of the first planetary gear unit 26 and the gear ratio ρ3 of the second planetary gear unit 28. In the relationships among the intervals between the vertical lines in the collinear diagram, when the interval between the vertical line corresponding to the sun gear and the vertical line corresponding to the carrier is expressed by 1, the interval between the vertical line corresponding to the carrier and the vertical line corresponding to the ring gear is expressed by the gear ratio ρ of the planetary gear unit. That is, in the coordinate system for the first shift unit 16, the interval between the vertical lines Y1 and Y2 is set to an interval corresponding to 1, and the interval between the vertical lines Y2 and Y3 is set to an interval corresponding to the gear ratio ρ0. Similarly, in the coordinate system for the second shift unit 20, the interval between the vertical line corresponding to the sun gear and the vertical line corresponding to the carrier is set to an interval corresponding to 1, and the interval between the vertical line corresponding to the carrier and the vertical line corresponding to the ring gear is set to an interval corresponding to the gear ratio p, at each of the planetary gear units 26 and 28.

As illustrated in the collinear diagram in FIG. 3, the transmission 30 in the first embodiment of the invention is structured in such a manner that, in the first shift unit 16 (power split mechanism 32), the first rotating element RE1 (carrier CA0) of the planetary gear unit 24 is connected to the engine 10 via the input shaft 14 and is selectively connected to the second rotating element RE2 (sun gear S0) via the switching clutch C0, the second rotating element RE2 is connected to the first electric motor M1 and is selectively connected to the case 12 via the switching brake B0, and the third rotating element RE3 (ring gear R0) is connected to the transmitting member 18 and the second electric motor M2 so that the rotation of the input shaft 14 is transmitted to the second shift unit 20 via the transmitting member 18. The relationship between the rotational speed of the first sun gear S1 and the rotational speed of the first ring gear R1 at this time is shown by a sloped straight line L0 that passes through the point of intersection of Y2 and X2.

When the switching clutch C0 and the switching brake B0 are both released, the transmission 30 is placed in the continuously variable shift mode (differential mode) in which the first rotating element RE1 to the third rotating element RE3 are allowed to rotated relative to each other. For example, when the transmission 30 is placed in the continuously variable shift mode (differential mode) in which the second rotating element RE2 and the third rotating element RE3 are allowed to rotate relative to each other at different rotational speeds, the rotational speed of the sun gear S0 is represented by the point of intersection of the straight line L0 and the vertical line Y1. When the rotational speed of the sun gear S0 is increased or decreased by controlling the rotational speed of the first electric motor M1, if the rotational speed of the ring gear R0, which is represented by the point of intersection of the straight line L0 and the vertical line Y3, is substantially constant, the rotational speed of the carrier CA1, which is represented by the point of intersection of the straight line L0 and the vertical line Y2, that is, the engine speed NE, is increased or decreased. When the sun gear S0 and the carrier CA1 are connected to each other by applying the switching clutch C0, the power split mechanism 32 is placed in the non-differential mode in which the three rotating elements RE1, RE2 and RE3 rotate together with each other and the second rotating element RE2 and the third rotating element RE3 are not allowed to rotate at different rotational speeds. Therefore, the straight line L0 matches the horizontal line X2, and the rotating member 18 rotates at the rotational speed equal to the engine speed NE. When the sun gear S0 is connected to the case 12 by applying the switching brake B0, the power split mechanism 32 is placed in the non-differential mode in which the rotation of the second rotating element RE2 is stopped and at least the second rotating element RE2 and the third rotating element RE3 are not allowed to rotate at different rotational speeds. Therefore, the straight line L0 is brought into the state shown in FIG. 3, and the first shift unit 16 functions as a speed-increasing mechanism. The rotation of the ring gear R0 having a speed represented by the point of intersection of the straight line L0 and the vertical line Y3, i.e., the rotational speed of the transmitting member 18, is input in the second shift unit 20. At this time, the rotational speed of the transmitting member 18 is higher than the engine speed NE.

In the second shift unit 20, the fourth rotating element RE4 is selectively connected to the transmitting member 18 via the second clutch C2, and selectively connected to the case 12 via the first brake B1. The fifth rotating element RE5 is selectively connected to the transmitting member 18 via the third clutch C3, and selectively connected to the case 12 via the second brake B2. The sixth rotating element RE6 is connected to the output shaft 22, and selectively connected the transmitting member 18 via the first clutch C1.

When the switching clutch C0, the first clutch C1 and the second brake B2 are applied, first gear is selected. As illustrated in FIG. 3, in the coordinate system for the second shift unit 20, the rotational speed of the output shaft 22 in first gear is represented by the point of intersection of i) a sloped straight line L1 that passes through both the point of intersection of the horizontal line X2 and the vertical line Y7 which represents the rotational speed of the seventh rotating element RE7 and the point of intersection of the horizontal line X1 and the vertical line Y5 which represents the rotational speed of the fifth rotating element RE5, and ii) the vertical line Y6 that represents the rotational speed of the sixth rotating element RE6 which is connected to the output shaft 22. When the switching brake B0, the first clutch C1 and the second brake B2 are applied, second gear is selected. The rotational speed of the output shaft 22 in second gear is represented by the point of intersection of a sloped straight line L2, which is defined by application of the switching brake B0, the first clutch C1 and the second brake B2, and the vertical line Y6 that represents the rotational speed of the sixth rotating element RE6 which is connected to the output shaft 22. When the switching clutch C0, the first clutch C1 and the first brake B1 are applied, third gear is selected. The rotational speed of the output shaft 22 in third gear is represented by the point of intersection of a sloped straight line L3, which is defined by application of the switching clutch C0, the first clutch C1 and the first brake B1, and the vertical line Y6 that represents the rotational speed of the sixth rotating element RE6 which is connected to the output shaft 22. When the switching brake B0, the first clutch C1 and the first brake B1 are applied, fourth gear is selected. The rotational speed of the output shaft 22 in fourth gear is represented by the point of intersection of a straight line L4, which is defined by application of the switching brake B0, the first clutch C1 and the first brake B1, and the vertical line Y6 that represents the rotational speed of the sixth rotating element RE6 which is connected to the output shaft 22. When the switching clutch C0, the first clutch C1 and the third clutch C3 are applied, fifth gear is selected. The rotational speed of the output shaft 22 in fifth gear is represented by the point of intersection of a horizontal straight line L5, which is defined by application of the switching clutch C0, the first clutch C1 and the third clutch C3, and the vertical line Y6 that represents the rotational speed of the sixth rotating element RE6 which is connected to the output shaft 22. When the switching clutch C0, the third clutch C3 and the first brake B1 are applied, sixth gear is selected. The rotational speed of the output shaft 22 in sixth gear is represented by the point of intersection of a straight line L6, which is defined by application of the switching clutch C0, the third clutch C3 and the first brake B1, and the vertical line Y6 that represents the rotational speed of the sixth rotating element RE6 which is connected to the output shaft 22. When the switching brake B0, the third clutch C3 and the first brake B1 are applied, seventh gear is selected. The rotational speed of the output shaft 22 in seventh gear is represented by the point of intersection of a sloped straight line L7, which is defined by application of the switching brake B0, the third clutch C3 and the first brake B1, and the vertical line Y6 that represents the rotational speed of the sixth rotating element RE6 which is connected to the output shaft 22. At first gear, third gear, fifth gear and sixth gear, the switching clutch C0 is applied. As a result, the rotation having the rotational speed equal to the engine speed NE is transmitted from the first shift unit 16, that is, the power split mechanism 32 to the fourth rotating element RE4, the fifth rotating element RE5 or the seventh rotating element RE7. At second gear, fourth gear and seventh gear, the switching brake B0 is applied instead of the switching clutch C0. As a result, the rotation having a rotational speed that is higher than the engine speed NE is transmitted from the first shift unit 16 to the fifth rotating element RE5 or the seventh rotating element RE7.

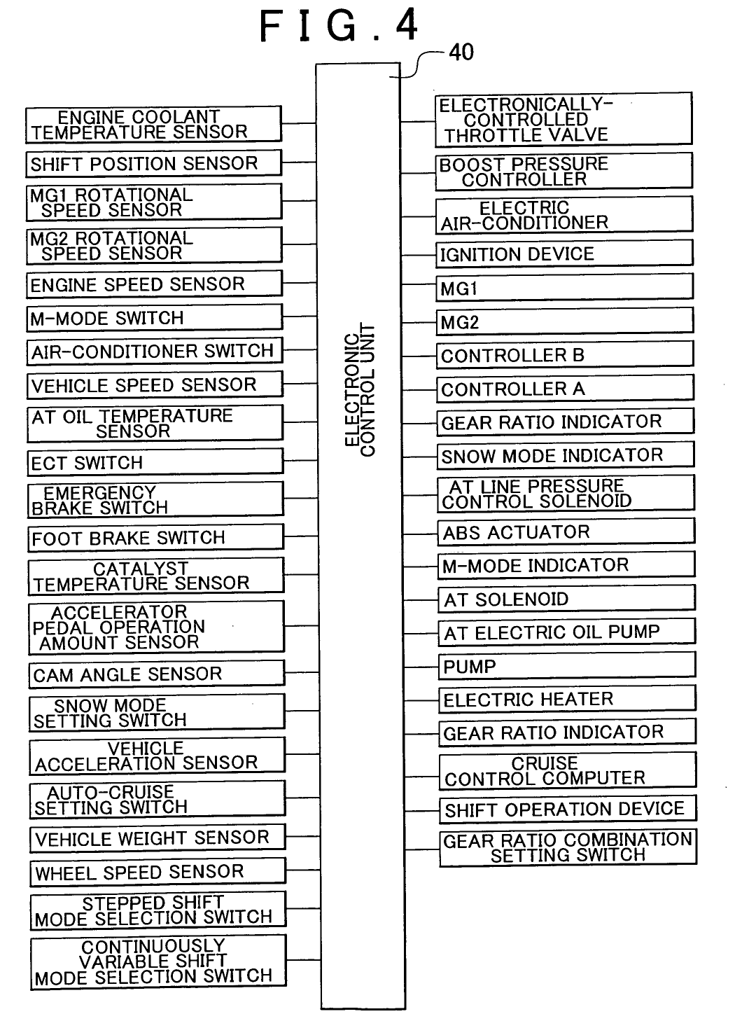

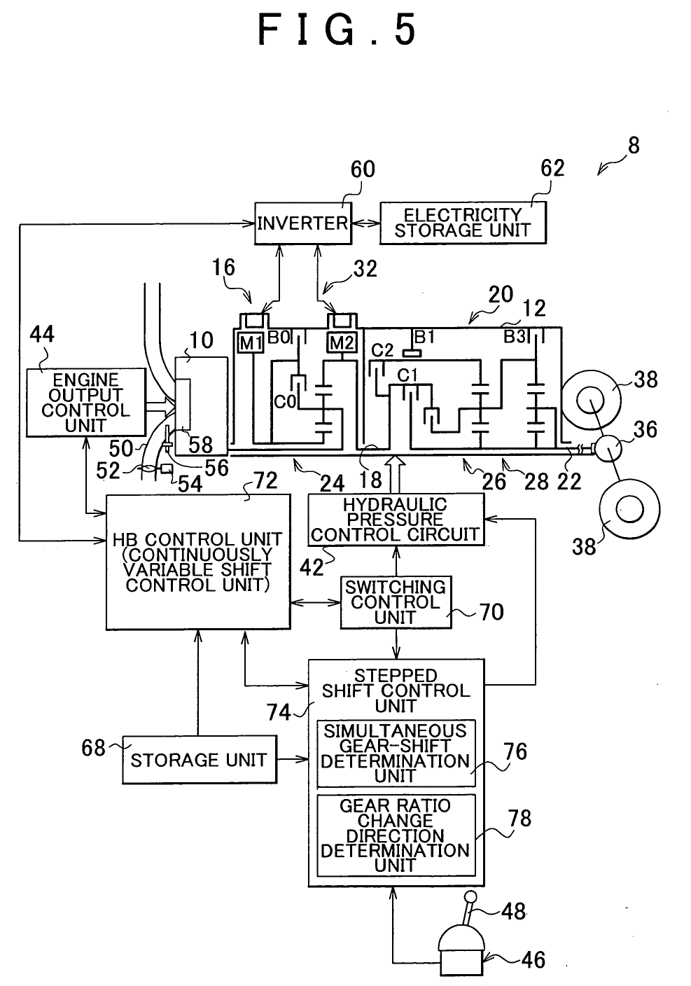

FIG. 4 shows examples of signals input in (received by) and output from an electronic control unit 40 that controls the power transmission apparatus 8 in the first embodiment of the invention. The electronic control unit 40 includes a so-called microcomputer that has a CPU, a ROM, a RAM, an input interface, an output interface, etc. The electronic control unit 40 executes the drive controls such as the drive control over the engine 10, the hybrid drive control with the use of the engine 10, the first electric motor M1 and the second electric motor M2, the shift control over the transmission 30 that serves as a continuously variable transmission or a stepped transmission, by processing signals according to programs pre-stored in the ROM while using the temporary storage function of the RAM.

Various signals are transmitted to the electronic control unit 40 from various sensors and switches. These signals include a signal indicating the engine coolant temperature TEMP_{W}, a signal indicating the shift position P_{SH}, a signal indicating the engine speed NE which is the rotational speed of the engine 10, a signal indicating the gear ratio combination setting value, a signal indicating a command to select the M-mode (manual shift cruise mode), a signal indicating operation of an air-conditioner, a signal indicating the vehicle speed V that corresponds to the rotational speed N_{OUT} of the output shaft 22, a signal indicating the temperature of the hydraulic fluid in the transmission 30, a signal indicating operation of an emergency brake, a signal indicating operation of a footbrake, a signal indicating the catalyst temperature, a signal indicating the accelerator. depression amount θACC that corresponds to the operation amount of an accelerator pedal, a signal indicating the cam angle, a signal indicating snow mode setting, a signal indicating the longitudinal acceleration G of the vehicle, a signal indicating auto-cruise running, a signal indicating the vehicle weight, signals indicating the wheel speeds, a signal indicating whether a stepped shift mode selection switch, which is used to place the first shift unit 16 (power split mechanism 32) in the stepped shift mode (locked mode) to have the transmission 30 function as a stepped shift unit, has been operated, a signal indicating whether a continuously variable shift mode selection switch, which is used to place the first shift unit 16 (power split mechanism 32) in the continuously variable shift mode (differential mode) to have the transmission 30 function as a continuously variable transmission, has been operated, a signal indicating the rotational speed N_{M1} of the first electric motor M1 (hereinafter, simply referred to as “first electric motor rotational speed N_{M1}”), a signal indicating the rotational speed N_{M2} of the second electric motor M2 (hereinafter, simply referred to as “second electric motor rotational speed N_{M2}”), and a signal indicating the state of charge (SOC) of an electricity storage unit 62 (see FIG. 5).

The electronic control unit 40 transmits various control signals to an engine output control apparatus 44 (see FIG. 5) to control the drive power output from the engine 10. These control signals include a drive signal provided to a throttle actuator 54 that controls the opening amount θTH of an electronically-controlled throttle valve 52 arranged in an intake pipe 50 of the engine 10, a fuel supply amount signal based on which the amount of fuel supplied into the intake pipe 50 or the cylinders of the engine 10 from a fuel injection device 56 is controlled, an ignition signal that indicates the ignition timing at which the air-fuel mixture is ignited by an ignition device 58, a boost pressure adjusting signal based on which the boost pressure is adjusted, an electric air-conditioner drive signal based on which an electric air-conditioner is operated, command signals based on which the electric motors M1 and M2 are operated, a shift position (operating position) indication signal based on which a shift range indicator is operated, a gear ratio indication signal based on which the gear ratio is indicated, a snow mode indication signal based on which the fact that the vehicle is being operated in the snow mode is indicated, an ABS activation signal based on which an ABS actuator that prevents the wheels from slipping when brakes are applied is actuated, a M-mode indication signal which indicates that the M-mode has been selected, valve command signals based on which electromagnetically-controlled valves in a hydraulic pressure control circuit 42 (see FIG. 5) are actuated to control hydraulic actuators for the hydraulic friction application devices in the first shift unit 16 and the second shift unit 20, a drive command signal based on which an electric oil pump which is a hydraulic pressure source for the hydraulic pressure control circuit 42 is operated, a signal based on which an electric heater is driven, and a signal that is provided to a computer used to execute the cruise control.

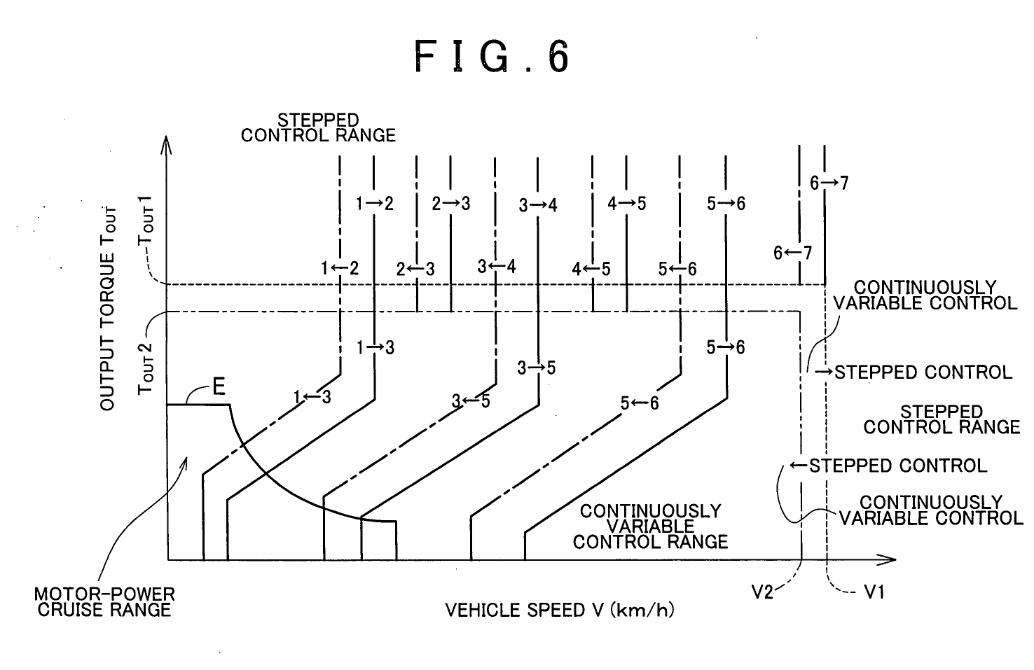

FIG. 5 is a functional block diagram illustrating the main part of the control operation executed by the electronic control unit 40. As shown in FIG. 5, a switching control unit 70 switches the shift mode of the first shift unit 16 between the differential mode and the non-differential mode (locked mode) by changing the application/release state of the switching clutch C0 or the switching brake B0, which serves as the switching application device, based on the vehicle condition. In other words, the switching control unit 70 switches the shift mode of the transmission 30 between the continuously variable shift mode and the stepped shift mode, and executes the control for selectively achieving these modes. For example, the switching control unit 70 determines whether the vehicle condition indicated by the required output torque T_{OUT} and the vehicle speed V is within the continuously variable range, in which the transmission 30 is placed in the continuously variable shift mode (the first shift unit 16 is placed in the differential mode), or in the stepped shift control range, in which the transmission 30 is placed in the stepped shift mode (the first shift unit 16 is placed in the non-differential mode), for example, based on whether the vehicle condition is within the continuously variable range or the stepped shift control range in FIG. 6 according to the relationships shown in FIG. 6, which are pre-stored in a storage unit 68. Then, the switching control unit 70 switches the shift mode of the transmission 30 from the continuously variable shift mode to the stepped shift mode by applying one of the switching clutch C0 and the switching brake B0, or from the stepped shift mode to the continuously variable shift mode by releasing both the switching clutch C0 and the switching brake B0.

When the switching control unit 70 determines that the vehicle condition indicated by the required output torque T_{OUT} and the vehicle speed V is within the stepped shift control range in FIG. 6, the switching control unit 70 transmits a signal for prohibiting the hybrid control or the continuously variable shift control to a hybrid control unit 72, permits a stepped shift control unit 74 to perform predetermined gear-shift in the stepped gear-shift operation, and applies the switching clutch C0 or the switching brake B0 based on the shift determination made by the stepped shift control unit 74. At this time, the stepped shift control unit 74 executes the automatic shift control over the first shift unit 16 and the second shift unit 20 to select one of the forward seven gears based on the shift diagram shown in FIG. 6, which is pre-stored in the storage unit 68, as will be described later in detail. FIG. 2 shows the combinations of the hydraulic friction application devices, that is, C0, C1, C2, C3, B0, B1 and B2, which are selected to select the respective gears. Thus, the transmission 30 as a whole, that is, the combination of the first shift unit 16 and the second shift unit 20, functions as a so-called stepped automatic transmission, and the gear is selected according to the operation chart shown in FIG. 2.

When the switching control unit 70 determines that the vehicle condition indicated by the required output torque T_{OUT} and the vehicle speed V is within the continuously variable shift control range in FIG. 6, the switching control unit 70 provides the hydraulic pressure control circuit 42 with a command for releasing the switching clutch C0 and the switching brake B0 to place the first shift unit 16 in the continuously variable shift mode, thereby placing the transmission 30 as a whole into the continuously variable shift mode. At the same time, the switching control unit 70 transmits a signal for permitting the hybrid control to the hybrid control unit 72, and provides the stepped shift control unit 74 with a signal for fixing the gear at the predetermined gear for the continuously variable shift mode or a signal for permitting automatic gear-shift according to the shift diagram shown in FIG. 6, which is pre-stored in the storage unit 68. In this case, the stepped shift control unit 74 selects one of the forward four gears of the second shift unit 20. In this case, the switching clutch C0 and the switching brake B0 need not be applied to perform gear-shift between the adjacent gears among these four gears. These four gears are first gear of the second shift unit 20 (gear ratio γA=3.683) that is selected by applying the first clutch C1 and the second brake B2, second gear of the second shift unit 20 (gear ratio γA=1.909) that is selected by applying the first clutch C1 and the first brake B1, third gear of the second shift unit 20 (gear ratio γA=1.000) that is selected by applying the first clutch C1 and the third clutch C3, and fourth gear of the second shift unit 20 (gear ratio γA=0.661) that is selected by applying the third clutch C3 and the first brake B1. As described above, when the first shift unit 16 that is placed in the continuously variable shift mode by the switching control unit 70 functions as a continuously variable shift unit and the second shift unit 20 that is connected in tandem with the first shift unit 16 functions as a stepped shift unit, an appropriate magnitude of drive power is obtained, and the rotational speed of the transmitting member 18, that is, the speed of rotation that is input to the second shift unit 20, which is at one of first gear of the second shift unit 20, second gear of the second shift unit 20, third gear of the second shift unit 20, and fourth gear of the second shift unit 20, is continuously changed so that gear ratio of each gear is allowed to change continuously. Accordingly, the gears are shifted while the gear ratio is continuously changed. As a result, the transmission 30 as a whole is placed in the continuously variable shift mode, and the total gear ratio γT, which is achieved by the transmission 30 as a while, is continuously changed.

The hybrid control unit 72 shown in FIG. 5 executes the hybrid drive control with the use of the engine 10, the first electric motor M1 and the second electric motor M2. The hybrid control unit 72 functions as a continuously variable shift control unit, for example, when the continuously variable shift mode is selected. When the transmission 30 is in the continuously variable shift mode, that is, when the first shift unit 16 is in the differential mode, the hybrid control unit 72 allows the engine 10 to operate in an efficient operation range, and controls the gear ratio γ0 of the first shift unit 16 that functions as an electric continuously variable shift unit, by optimizing the ratio between the drive power supplied from the engine 10 and the drive power supplied from the second electric motor M2, and optimizing the reaction force borne by the first electric motor M1, and controls the total gear ratio γT of the transmission 30 in a continuously variable manner. For example, the hybrid control unit 72 calculates the target (required) drive power used to drive the vehicle based on the accelerator-pedal operation amount ACC, which indicates the amount of drive power required by the driver, and the vehicle speed V, calculates the total target drive power based on the target drive power used to drive the vehicle and the required value for charging an electric power storage unit, calculates the target drive power output from the engine 10 so that the total target drive power is output from the engine, taking into account a transfer loss, loads placed on auxiliary machines, an assist torque supplied from the second electric motor M2, and the like, controls the total gear ratio γT and the drive power output from the engine 10 so that the engine speed NE and the engine torque T_{E} are adjusted to obtain the target drive power, and controls the amount of electric power generated by the first electric motor M1.

The hybrid control unit 72 executes the continuously variable shift control with the gear of the second shift unit 20 taken into account to improve the power performance of the power transmission apparatus 8, the fuel efficiency, and the like. During such hybrid control, the first shift unit 16 functions as an electric continuously variable shift unit to coordinate the engine speed NE, which is set to operate the engine 10 in the efficient operation range, and the rotational speed of the transmitting member 18, which is set based on the vehicle speed V and the gear of the second shift unit 20. That is, the hybrid control unit 72 sets the target value for the total gear ratio γT of the transmission 30 so that the engine 10 operates according to the optimum fuel efficiency curve (fuel efficiency map, relational diagram). The optimum fuel efficiency curve is empirically determined in advance in a two-dimension coordinate system that uses the engine speed NE and the torque T_{E} output from the engine 10 (engine torque T_{E}) as parameters so that high drivability and high fuel efficiency are achieved when the vehicle is driven in the continuously variable shift mode. The optimum fuel efficiency curve is stored in the storage unit 68. For example, the hybrid control unit 72 sets the target value for the total gear ratio γT of the transmission 30 so that the engine torque T_{E} and the engine speed NE, at which the drive power output from the engine 10 matches the target drive power (total target drive power, or required drive power), are achieved. Then, the hybrid control unit 72 controls the gear ratio γ0 of the first shift unit 16 with the gear of the transmission 30 taken into account so that the target drive power is obtained, thereby controlling the total gear ratio γT within a range, for example, from 0.5 to 13, in which the total gear ratio γT is allowed to be changed. In this case, the hybrid control unit 72 supplies the electric energy generated by the first electric motor M1 to the electricity storage unit 62 and the second electric motor M2 via an inverter 60. Accordingly, the main portion of the drive power generated by the engine 10 is mechanically transmitted to the transmitting member 18, while part of the drive power generated by the engine 10 is consumed by the first electric motor M1 to generate electric power, that is, part of the drive power generated by the engine 10 is converted into electric energy at the first electric motor M1. The electric energy is supplied to the second electric motor M2 via the inverter 60. The electric energy is used to drive the second electric motor M2, and the drive power generated by the second electric motor M2 is transmitted to the transmitting member 18. The devices related to the process from generation of the electric energy to consumption of the electric energy in the second electric motor M2 constitute an electric path in which part of the power output from the engine 10 is converted into the electric energy, and the electric energy is converted to the mechanical energy.

The hybrid control unit 72 executes the output control (drive control) over engine 10 using the engine output control unit 44. That is, the hybrid control unit 72 makes the engine output control unit 44 execute the throttle control, namely, open or close the electronically-controlled throttle valve 52 using the throttle actuator 54. Also, the hybrid control unit 72 makes the engine output control unit execute the fuel injection control, namely, control the amount of fuel injected from the fuel injection device 56 and the fuel injection timing. In addition, the hybrid control unit 72 makes the engine output control unit 44 execute the ignition timing control, that is, control the timing of ignition performed by the ignition device 58, for example, an igniter. The hybrid control unit 72 makes the engine output control unit 44 output at least one of commands related to the throttle control, the fuel injection control, and the ignition control, thereby executing the output control over the engine 10 to obtain the required drive power. The engine output control unit 44 executes the engine torque control according to commands from the hybrid control unit 72. More specifically, the engine output control unit 44 executes the throttle control, that is, opens or closes the electronically-controlled throttle valve 52 using the throttle actuator 54, executes the fuel injection control, that is, controls the fuel injection performed by the fuel injection device 56, and executes the ignition timing control, that is, controls the timing of ignition performed by the ignition device 58 such as an igniter.

The hybrid control unit 72 allows the vehicle to move using the drive power generated by the motor with the electric CVT function (differential function) of the first shift unit 16, even if the engine 10 is at a standstill or idling. A solid line E in FIG. 6 is a boundary line between an engine-power cruise range and a motor-power cruise range. The boundary line is used to determine whether the drive power source, which generates the drive power used to start and drive the vehicle, should be changed between the engine 10 and a motor, for example, the second electric motor M2. In other words, the boundary line is used to determine whether the cruise mode should be changed between a so-called engine-power cruise mode in which the vehicle is started and driven using the engine 10 as a drive power source, and a so-called motor-power cruise mode in which the vehicle is driven using the second electric motor M2 as a drive power source. The pre-stored relational diagram, shown in FIG. 6, which includes the boundary line (indicated by the solid line E) used to determine whether the cruise mode should be changed between the engine-power cruise mode and the motor-power cruise mode, is an example of drive power source switching diagram (drive power source map) that is formed of a two-dimensional coordinate system that uses the vehicle speed V and the output torque T_{OUT} which is a value related to drive power as parameters. This drive power source switching diagram is pre-stored in the storage unit 68 along with, for example, the shift diagram (shift map) indicated by solid lines and alternate long and short dash lines in FIG. 6. The hybrid control unit 72 determines whether the vehicle condition indicated by the vehicle speed V and the required torque T_{OUT} is within the motor-power cruise range or the engine-power cruise range using the drive power source switching diagram shown in FIG. 6. Then, the hybrid control unit 72 drives the vehicle in the motor-power cruise mode or the engine-power cruise mode. As is clear from FIG. 6, the hybrid control unit 72 drives the vehicle in the motor-power cruise mode in the low output torque range, that is, in the low engine torque range where the engine efficiency is lower than that in the high torque range, or in the low vehicle speed range where the vehicle speed V is relatively low, that is, the low load range. Accordingly, when the vehicle is started, usually, the drive power generated by the motor is preferentially used instead of the drive power generated by the engine. However, if the accelerator pedal is depressed by an amount that is so large that the required output torque T_{OUT} exceeds the output torque T_{OUT} corresponding to the upper limit of the motor-power cruise range in the drive power source switching diagram in FIG. 6, that is, the required output torque T_{OUT} is as large as the required engine torque T_{E}, the vehicle is started using the drive power generated by the engine.

When the vehicle is driven in the motor-power cruise mode, in order to suppress dragging of the engine 10 which is at a standstill to improve the fuel efficiency, the hybrid control unit 72 may control the first electric motor rotational speed N_{M1} to a negative rotational speed, for example, an idle speed, with the electric CVT function (differential function) of the first shift mode 16 and maintain the engine speed NE at substantially zero, if necessary, with the differential function of the first shift unit 16 that functions as a differential unit.

Even when the vehicle is driven in the engine-power cruise mode, the hybrid control unit 72 is able to perform so-called torque-assist operation to complement the drive power generated by the engine 10, by supplying the second electric motor M2 with at least one of the electric energy from the first electric motor M1 and the electric energy from the electricity storage unit 62 via the electric path and then driving the second electric motor M2 using the electric energy to supply the torque to the drive wheels 38. Therefore, the term “engine-power cruise” in the first embodiment of the invention also includes the situation where the vehicle is driven by the drive power from the engine and the drive power from the motor.

Also, the hybrid control unit 72 is able to maintain the engine speed NE at a substantially constant speed or control the engine speed NE to a desired speed by controlling at least one of the first electric motor rotational speed N_{M1} the second electric motor rotational speed N_{M2} with the electric CVT function of the first shift unit 16, regardless of whether the vehicle is at a standstill or moving. For example, as is clear from the shift diagram in FIG. 3, when the engine speed NE is increased while the vehicle is moving, the hybrid control unit 72 maintains the second electric motor rotational speed N_{M2} that depends on the vehicle speed V (wheel speed of the drive wheels 38) at a substantially constant speed while increasing the first electric motor rotational speed N_{M1}.

The stepped shift control unit 74 shown in FIG. 5 executes the automatic shift control over the transmission 30 that is formed of the first shift unit 16 and the second shift unit 20. For example, the stepped shift control unit 74 determines whether the gears of the transmission 30 should be shifted based on the vehicle condition that is indicated by the vehicle speed V and the required output torque T_{OUT} for the second shift unit 20 according to the shift diagram (relational diagram, shift map) that includes the solid lines and the alternate long and short dash lines in FIG. 6, which is pre-stored in the storage unit 68, and executes the automatic shift control over the transmission 30 so that the determined gear is selected. At this time, the stepped shift control unit 74 directly or indirectly provides the hydraulic pressure control circuit 42 with a command (shift output command, hydraulic pressure command) for applying and/or releasing the hydraulic friction application devices related to the gear-shift, which include the switching clutch C0 and the switching brake B0, so that the determined gear is selected according to the operation chart shown in FIG. 2. In the hydraulic pressure control circuit 42, the electromagnetically-controlled valves are operated to operate hydraulic actuators for the hydraulic friction application devices related to the gear-shift so that the hydraulic friction application device that should be released in the gear-shift is released and the hydraulic friction application device that should be applied in the gear-shift is applied according to the command from the electronic control unit 40. In this way, the gears of the transmission 30 are shifted.

FIG. 6 will be described in detail below. FIG. 6 shows the shift diagram (relational diagram, shift map) which is pre-stored in the storage unit 68 and which is formed of a two-dimensional coordinate system that uses the vehicle speed V and the required output torque T_{OUT}, which is a value related to the drive power, as parameters. In FIG. 6, the solid lines are upshift lines and the alternate long and short dash lines are downshift lines. A broken line in FIG. 6 represents the reference vehicle speed V1 and the reference output torque T_{OUT}1 used by the switching control unit 70 to determine whether the shift mode should be switched from the continuously variable shift mode to the stepped shift mode. That is, the broken line in FIG. 6 includes both a high vehicle speed determination line and a high output determination line. The high vehicle speed determination line indicates the reference vehicle speed V1 which is a predetermined value that is used to determine whether the vehicle is traveling at a high vehicle speed. The high output determination line indicates the reference output torque T_{OUT}1 which is a predetermined value that is used to determine whether the value related to the drive power required by the hybrid vehicle is high, for example, whether the output torque T_{OUT} from the second shift unit 20 should be high. Moreover, there is provided a hysteresis range indicated by the alternate long and two short dash line and the broken line in FIG. 6. The hysteresis range is between the stepped control range and the continuously variable control range. Therefore, the hysteresis effect is produced in the determination as to whether the vehicle condition is within the stepped control range or the continuously variable control range. That is, FIG. 6 shows a pre-stored switching diagram (switching map, relational diagram), which includes the reference vehicle speed V1 and the reference output torque T_{OUT}1, which uses the vehicle speed V and the output torque T_{OUT} as parameters, and which is used when the switching control unit 70 determines whether the vehicle condition is within the stepped control range or the continuously variable control range. The switching diagram may include at least one of the reference vehicle speed V1 and the reference output torque T_{OUT}1, or may include a pre-stored switching line that uses the vehicle speed V or the output torque T_{OUT} as a parameter.

The above-described shift diagram, switching diagram, drive power source switching diagram or the like may be stored in the form of a determination expression for comparing the actual vehicle speed V with the reference vehicle speed V1 and a determination expression for comparing the output torque T_{OUT} with the reference output torque T_{OUT}1, instead of in the form of a map. In this case, the switching control unit 70 determines, for example, whether the actual vehicle speed V exceeds the reference vehicle speed V1. If it is determined that the actual vehicle speed V exceeds the reference vehicle speed V1, the switching control unit 70 places the transmission 30 in the stepped shift mode by applying the switching clutch C0 or the switching brake B0. Also, the switching control unit 70 determines whether the output torque T_{OUT} from the second shift unit 20 exceeds the reference output torque T_{OUT}1. If it is determined that the output torque T_{OUT} from the second shift unit 20 exceeds the reference output torque T_{OUT}1, the switching control unit 70 places the transmission 30 in the stepped shift mode by applying the switching clutch C0 or the switching brake B0.

As described above, the ordinate axis in FIG. 6 represents the output torque T_{OUT}. However, the ordinate axis may represent any value that is related to the required drive power. The value related to the required drive power is a parameter that corresponds one-to-one with the drive power required by the vehicle. This value is not limited to the drive torque or drive power required by the drive wheels 38, but may also be the value of, for example, the required output torque T_{OUT} for the second shift unit 20, the required engine torque T_{E}, the required vehicle acceleration G, or the engine torque T_{E} that is calculated based on the accelerator pedal operation amount θACC or the throttle valve opening amount θ_{TH} (or the intake air amount, the air-fuel ratio, or the fuel injection quantity) and the engine speed NE. The drive torque may be calculated based on, for example, the output torque T_{OUT} with the differential ratio, the radius of the drive wheel 38, etc. taken into account, or may be directly detected using, for example, a torque sensor. The other torques mentioned above may also be calculated or detected in this way. If the transmission 30 is placed in the continuously variable shift mode when the vehicle is traveling at a high vehicle speed, the fuel efficiency is decreased. In order to avoid such a situation, the reference vehicle speed V1 is set. If the vehicle speed is higher than the reference vehicle speed V1, the transmission 30 is placed in the stepped shift mode. The reference output torque T_{OUT}1 is set based on, for example, the characteristics of the first electric motor M1, which are exhibited when the maximum value of the electric energy from the first electric motor M1 is appropriately decreased. In this way, when a large amount of drive power is required to drive the vehicle, a reaction torque from the first electric motor M1 is not required for an engine torque within a high torque range. As a result, the size of the first electric motor M1 is reduced.

As shown in FIG. 6, the high torque range in which the output torque T_{OUT} is equal to or higher than the predetermined reference output torque T_{OUT}1, and the high vehicle speed range in which the vehicle speed V is equal to or higher than the predetermined reference vehicle speed V1, are used as the stepped control ranges. Therefore, the vehicle is driven in the stepped shift mode when the torque from the engine 10 is relatively high or when the vehicle speed is relatively high. On the other hand, the vehicle is driven in the continuously variable shift mode when the torque from the engine 10 is relatively low or when the vehicle speed is relatively low, namely, when the engine 10 is required to generate drive power within a regular drive power range. Accordingly, for example, when the vehicle is traveling at a low or medium speed or when a small or medium amount of drive power is required to drive the vehicle, the transmission 30 is placed in the continuously variable shift mode to maintain favorable fuel efficiency. Meanwhile, because the second shift unit 20 functions as a four-speed transmission, the maximum value of the electric energy that should be generated by the first electric motor M1 (electric energy that should be output from the first electric motor M1) is minimized. As a result, the size of the first electric motor 1 or the vehicle drive system including the first electric motor M1 is further reduced. On the other hand, when the vehicle is traveling at a high speed, for example, when the vehicle speed V is higher than the reference vehicle speed V1, or when a large amount of drive power is required to drive the vehicle, for example, when the output torque T_{OUT} exceeds the reference torque T_{OUT}1, the transmission 30 is placed in the stepped shift mode in which the transmission 30 operates as a stepped transmission. In this case, the drive power output from the engine 10 is transmitted to the drive wheels 38 along the mechanical power transmission path. Therefore, it is possible to suppress loss due to conversion between drive power and electric energy, which occurs when the transmission 30 operates as an electric continuously variable transmission. As a result, the fuel efficiency is improved.

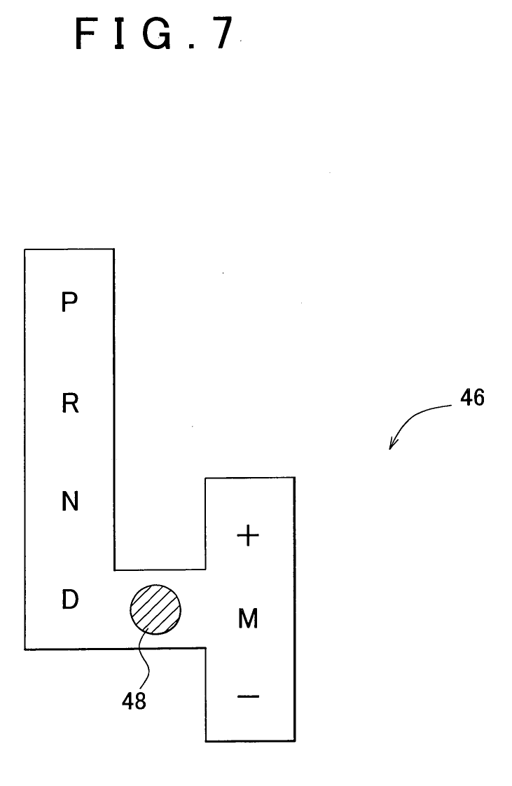

FIG. 7 is a view showing an example of a shift change device 46 that is used to manually select one of multiple shift positions. The shift change device 46 is provided, for example, next to the driver's seat, and includes a shift lever 48 that is operated to select one of the multiple shift positions. The shift lever 48 is manually operated to one of Park, Reverse, Neutral, Drive and Manual. When the shift lever 48 is in Park, the neutral state in which the power transmission path within the transmission 30 (second shift unit 20) is shut off is achieved, that is, neither the first clutch C1 nor the second clutch C2 is applied, and the output shaft 22 of the second shift unit 20 is locked. When the shift lever 48 is in Reverse, the vehicle backs up. When the shift lever 48 is in Neutral, the neutral state in which the power transmission path within the transmission 30 is shut off is achieved. When the shift lever 48 is in Drive, the vehicle moves forward. When the shift lever 48 is in Manual, the vehicle moves forward while the transmission is manually operated. For example, when Drive is selected by operating the shift lever 48, the shift mode of the transmission 30 is automatically switched by the switching control unit 70 based on the pre-stored shift map or switching map shown in FIG. 6, the continuously variable shift control is executed over the first shift unit 16 by the hybrid control unit 72, and the automatic shift control is executed over the transmission 30 by the stepped shift control unit 74. Also, Drive is a shift position used to select the automatic shift cruise mode (automatic mode) in which the automatic shift control is executed over the transmission 30. When Manual is selected by operating the shift lever 48 and the vehicle is moving in the stepped shift mode in which the transmission 30 is placed in the stepped shift mode, the automatic shift control is executed over the transmission 30 so that one of gears that is equal to or lower than a predetermined upper limit gear is selected or a designated gear is selected. Manual is also a shift position used to select the manual shift cruise mode (manual mode) in which the manual shift control is executed over the transmission 30.

In the transmission 30 according to the first embodiment of the invention, forward seven gears are set in order to reduce the difference between the gear ratios of the adjacent gears (close-ratio) and increase the gear ratio width (gear ratio of the lowest gear/gear ratio of the highest gear). Therefore, in the stepped shift control in which the total gear ratio γT of the transmission 30 is changed in a stepped manner, the gear-shift of the first shift unit 16 (releasing one of the switching clutch C0 and the switching brake B0, and applying the other of the switching clutch C0 and the switching brake B0) and the gear-shift of the second shift unit 20 may be performed at the same time, that is, the simultaneous gear-shift may take place. As described above, when the gear-shift of the first shift unit 16 and the gear-shift of the second shift unit 20 are performed at the same time, the gear ratio γ0 of the first shift unit 16 is changed by the clutch-to-clutch gear-shift of the first shift unit 16, and the gear ratio γA of the second shift unit 20 is changed by the clutch-to-clutch gear-shift of the second shift unit 20. In this case, the gear ratio γ0 of the first shift unit 16 and the gear ratio γA of the second shift unit 20 may change in the opposite directions. In other words, in the simultaneous gear-shift in which the gear-shift of the first shift unit 16 and the gear-shift of the second shift unit 20 are performed at the same time, the gear-shift of the first shift unit 16 changes the engine speed NE in one direction and the gear-shift of the second shift unit 20 changes the engine speed NE in the direction opposite to the direction in which the engine speed NE is changed by the gear-shift of the first shift unit 16. For example, the engine speed NE is decreased by the gear-shift of the first shift unit 16 and, at the same time, the engine speed NE is increased by the gear-shift of the second shift unit 20. For example, in the gear-shift from second gear 2^{nd} to third gear 3^{rd} shown in FIG. 2, the direction in which the gear ratio is changed by the gear-shift of the first shift unit 16 differs from the direction in which the gear ratio is changed by the gear-shift of the second shift unit 20, that is, the gear ratio γ0 of the first shift unit 16 increases while the gear ratio γA of the second shift unit 20 decreases. In such a case, the engine speed NE may fluctuate if the timing of the gear-shift of the first shift unit 16 and the timing of the gear-shift of the second shift unit 20 are slightly off, which may give a sense of discomfort to occupants as shift shock.

In order to suppress such shift shock, in the simultaneous gear-shift which is performed under the control executed by the stepped shift control unit 74 and in which the gear-shift of the first shift unit 16 and the gear-shift of the second shift unit 20 are performed at the same time, the hybrid control unit 72 included in the electronic control unit 40 executes the supplemental control with the use of at least one of the first electric motor M1 and the second electric motor M2. The supplemental control is executed in order to appropriately maintain the characteristic control (shift control) over the first shift unit 16 and the second shift unit 20 executed with the use of the hydraulic friction application devices, that is, the brakes Brand the clutches C.

In order to execute the supplemental control, as shown in FIG. 5, a simultaneous gear-shift determination unit 76 and a gear ratio change direction determination unit 78 are provided in the stepped shift control unit 74. When the stepped shift control unit 74 determines that a gear-shift takes place, the simultaneous gear-shift determination unit 76 determines whether the gear-shift is a simultaneous gear-shift in which the gear ratio γ0 of the first shift unit 16 and the gear ratio γA are changed at the same time. That is, it is determined whether the detected gear-shift corresponds to the simultaneous gear-shift based on the vehicle condition indicated by the vehicle speed V and the required output torque T_{OUT} according to the relational diagram shown in FIG. 6. When the stepped shift control unit 74 determines that a gear-shift takes place, the gear ratio change direction determination unit 78 determines whether the gear-shift is a gear-shift in which the gear ratio γ0 of the first shift unit 16 and the gear ratio γA of the second shift unit 20 change in the opposite directions. That is, the gear ratio change direction determination unit 78 determines whether the detected gear-shift corresponds to a gear-shift in which the gear ratio γ0 of the first shift unit 16 and the gear ratio γA of the second shift unit 20 change in the opposite directions based on the vehicle condition indicated by the vehicle speed V and the required output torque T_{OUT} according to the relational diagram shown in FIG. 6.

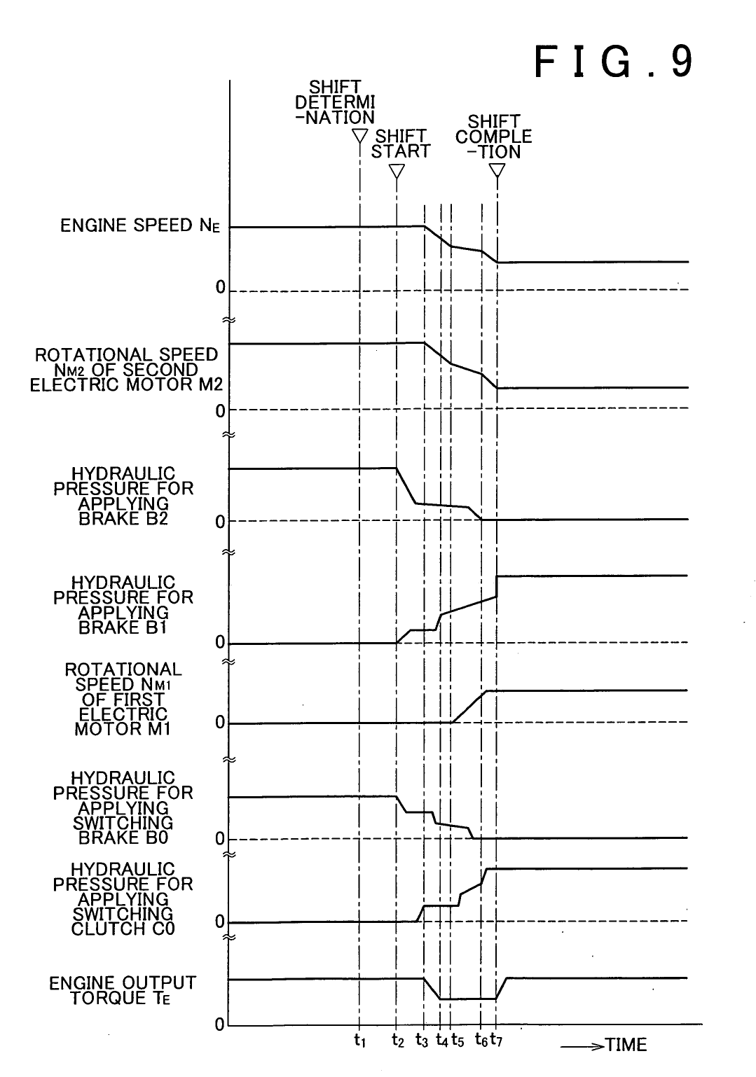

When the gear-shift of the first shift unit 16 and the gear-shift of the second shift unit 20 are performed at the same time and the gear ratio γ0 of the first shift unit 16 and the gear ratio γA of the second shift unit 20 change in the opposite directions, that is, when both the simultaneous gear-shift determination unit 76 and the gear ratio change direction determination unit 78 make affirmative determinations, the hybrid control unit 72 executes the control with the use of at least one of the first electric motor M1 and the second electric motor M2 so that the direction in which the rotational speed NE of the engine 10 is changed by the gear-shift of the first shift unit 16 constantly matches the direction in which the rotational speed NE of the engine 10 is changed by the gear-shift of the second shift unit 20 throughout the gear-shift. As described above with reference to FIG. 3, the first electric motor M1 is able to control the rotational speed NE of the engine 10 by controlling the rotation of the second rotating element RE2. The hybrid control unit 72 controls the manner in which the rotational speed NE of the engine 10 changes through the rotation control over the second rotating element RE2 that is executed with the use of the first electric motor M1. That is, as shown in the time chart in FIG. 9 which will be described later in detail, when the simultaneous gear-shift of the first shift unit 16 and the second shift unit 20 is performed, the rotational speed NE of the engine 10 is controlled by the first electric motor M1 so that the rotational speed NE of the engine 10 is either consistently increased (in the case of downshifting) or consistently decreased (in the case of upshifting) throughout the simultaneous gear-shift. In other words, when the simultaneous gear-shift of the first shift unit 16 and the second shift unit 20 is performed, the rotational speed NE of the engine 10 is controlled by the first electric motor M1 so that the rotational speed NE of the engine 10 is monotonously increased (in the case of downshifting) or monotonously decreased (in the case of upshifting) throughout the simultaneous gear-shift.

The hybrid control unit 72 controls the rotation of the first electric motor M1 based on a change in the speed of rotation that is input in the second shift unit 20, that is, a change in the rotational speed of the transmitting member 18 according to the predetermined relationship in order to control the direction in which the rotational speed NE of the engine 10 is changed in the simultaneous gear-shift of the first shift unit 16 and the second shift unit 20. In other words, the hybrid control unit 72 controls the rotational speed of the electric motor M1 based on a change in the speed of rotation that is input in the second shift unit 20. As described above, the rotation of the first electric motor M1 is controlled in such a manner that when the simultaneous gear-shift of the first shift unit 16 and the second shift unit 20 is performed, the direction in which the rotational speed NE of the engine 10 is changed by the gear-shift of the first shift unit 16 matches the direction in which the rotational speed NE of the engine 10 is changed by the gear-shift of the second shift unit 20. Preferably, the feed-forward control or the feedback control is executed over the rotational speed N_{M1} of the first electric motor M1 (consequently, rotational speed NE of the engine 10) based on the speed of rotation that is input in the second shift unit 20. Alternatively, the learning control may be executed, and the rotational speed N_{M1} of the first electric motor M1 may be controlled based on the states of the preceding gear-shifts.

When both the simultaneous gear-shift determination unit 76 and the gear ratio change direction determination unit 78 make affirmative determinations, the hybrid control unit 72 controls at least one of the timing at which the inertia phase of the gear-shift of the first shift unit 16 is started and the timing at which the inertia phase of the gear-shift of the second shift unit 20 is started. More specifically, the hybrid control unit 72 executes the control for advancing the timing at which the inertia phase of the gear-shift of the second shift unit 20 is started with respect to the timing at which the inertia phase of the gear-shift of the first shift unit 16 is started with the use of at least one of the first electric motor M1 and the second electric motor M2. Alternatively, the hybrid control unit 27 executes the control for restricting the start of the inertia phase of the gear-shift of the first shift unit 16 with the use of at least one of the first electric motor M1 and the second electric motor M2, that is, the control for holding back the start of the inertia phase of the gear-shift of the first shift unit 16 to retard the timing at which the inertia phase of the gear-shift of the first shift unit 16 is started with respect to the timing at which the inertia phase of the gear-shift of the second shift unit 20 is started. That is, when the gear-shift of the first shift unit 16 and the gear-shift of the second shift unit 20 are performed at the same time and the gear ratio γ0 of the first shift unit 16 and the gear ratio γA of the second shift unit 20 change in the opposite directions, the hybrid control unit 72 executes at least the control for retarding the timing at which the inertia phase of the gear-shift of the first shift unit 16 is started with respect to the timing at which the inertia phase of the gear-shift of the second shift unit 20 is started.

When the gear-shift of the first shift unit 16 and the gear-shift of the second shift unit 20 are performed at the same time and the gear ratio γ0 of the first shift unit 16 and the gear ratio γA of the second shift unit 20 change in the opposite directions, that is, when both the simultaneous gear-shift determination unit 76 and the gear ratio change direction determination unit 78 make affirmative determinations, the hybrid control unit 72 controls at least one of the timing at which the inertia phase of the gear-shift of the first shift unit 16 is completed and the timing at which the inertia phase of the gear-shift of the second shift unit 20 is completed with the use of the electric motor M. More specifically, the hybrid control unit 72 executes the control for advancing the timing at which the inertia phase of the gear-shift of the first shift unit 16 is completed with respect to the timing at which the inertia phase of the gear-shift of the second shift unit 20 is completed with the use of at least one of the first electric motor M1 and the second electric motor M2. Alternatively, the hybrid control unit 72 execute the control for restricting completion of the inertia phase of the gear-shift of the second shift unit 20 with the use of at least one of the first electric motor M1 and the second electric motor M2 during the gear-shift of the first shift unit 16, that is, the control for holding back the completion of the inertia phase of the gear-shift of the second shift unit 20 to retarding the timing at which the inertia phase of the gear-shift of the second shift unit 20 is completed with respect to the timing at which the inertia phase of the gear-shift of the first shift unit 16 is completed. That is, when the gear-shift of the first shift unit 16 and the gear-shift of the second shift unit 20 are performed at the same time and the gear ratio γ0 of the first shift unit 16 and the gear ratio γA of the second shift unit 20 change in the opposite directions, the hybrid control unit 72 executes at least the control for retarding the timing at which the inertia phase of the gear-shift of the second shift unit 20 is completed with respect to the timing at which the inertia phase of the gear-shift of the first shift unit 26 is completed.

When both the simultaneous gear-shift determination unit 76 and the gear ratio change direction determination unit 78 make affirmative determinations, the hybrid control unit 72 executes the control so that the inertia phase of the gear-shift of the first shift unit 16 is started and completed within a period from when the inertia phase of the gear-shift of the second shift unit 20 is started until when the inertia phase of the gear-shift of the second shift unit 20 is completed. That is, the hybrid control unit 72 executes the control for advancing the timing at which the inertia phase of the gear-shift of the second shift unit 20 is started with respect to the timing at which the inertia phase of the gear-shift of the first shift unit 16 is started or the control for retarding the timing at which the inertia phase of the gear-shift of the first shift unit 16 is started with respect to the timing at which the inertia phase of the gear-shift of the second shift unit 20 is started. In addition, the hybrid control unit 72 executes the control for advancing the timing at which the inertia phase of the gear-shift of the first shift unit 16 is completed with respect to the timing at which the inertia phase of the gear-shift of the second shift unit 20 is completed or the control for retarding the timing at which the inertia phase of the gear-shift of the second shift unit 20 is completed with respect to the timing at which the inertia phase of the gear-shift of the first shift unit 16 is completed.

When both the simultaneous gear-shift determination unit 76 and the gear ratio change direction determination unit 78 make affirmative determinations, the hybrid control unit 72 switches the shift mode of the first shift unit 16 between the continuously variable shift mode and the stepped shift mode within a period from when the inertia phase of the gear-shift of the second shift unit 20 is started until when the inertia phase of the gear-shift of the second shift unit 20 is completed. That is, the hybrid control unit 72 executes the control for advancing the timing at which the inertia phase of the gear-shift of the second shift unit 20 is started with respect to the timing at which switching of the shift mode of the first shift unit 16 is actually started or the control for retarding the timing at which switching of the shift mode of the second shift unit 20 is actually started with respect to the timing at which the inertia phase of the gear-shift of the second shift unit 20 is started. In addition, the hybrid control unit 72 executes the control for advancing the timing at which switching of the shift mode of the first shift unit 16 is actually completed with respect to the timing at which the inertia phase of the gear-shift of the second shift unit 20 is completed or the control for retarding the timing at which the inertia phase of the gear-shift of the second shift unit 20 is completed with respect to the timing at which switching of the shift mode of the first shift unit 16 is actually completed.

The first electric motor M1 is connected to the second rotating element RE2 (sun gear S0) of the first shift unit 16, of which the rotational speed changes in accordance with the gear-shift of the first shift unit 16, and the hybrid control unit 72 controls the inertia phase of the gear-shift of the first shift unit 16 by controlling the rotation of the second rotating element RE2 with the use of the first electric motor M1. The second electric motor M2 is connected to the third rotating element RE3 (transmitting member 18) of the second shift unit 20, of which the rotational speed changes in accordance with the gear-shift of the second shift unit 20, and the hybrid control unit 72 controls the inertia phase of the gear-shift of the second shift unit 20 by controlling the rotation of the third rotating element RE3 with the use of the second electric motor M2.

In other words, during the gear-shift of one of the first shift unit 16 and the second shift unit 20, the hybrid control unit 72 controls at least one of the start timing and the completion timing of the inertia phase of the gear-shift of the other of the first shift unit 16 and the second shift unit 20 with the use of the electric motor M, which is selected from the first electric motor M1 and the second electric motor M2, and which is connected to the rotating element related to the gear-shift of the other of the first shift unit 16 and the second shift unit 20. Preferably, during the gear-shift of the second shift unit 20, the hybrid control unit 72 controls at least one of the start timing and the completion timing of the inertia phase of the gear-shift of the first shift unit 16 with the use of the first electric motor M1. Preferably, the transitional control with the use of the first electric motor M1 during the gear-shift is executed in a feedback manner based on the speed of rotation input in the second shift unit 20. Alternatively, the learning control may be applied to control the hydraulic pressures that are supplied to the actuators (brakes B, clutches C), especially, the actuator that should be released or the actuator that should be applied based on the progress of the preceding gear-shift.

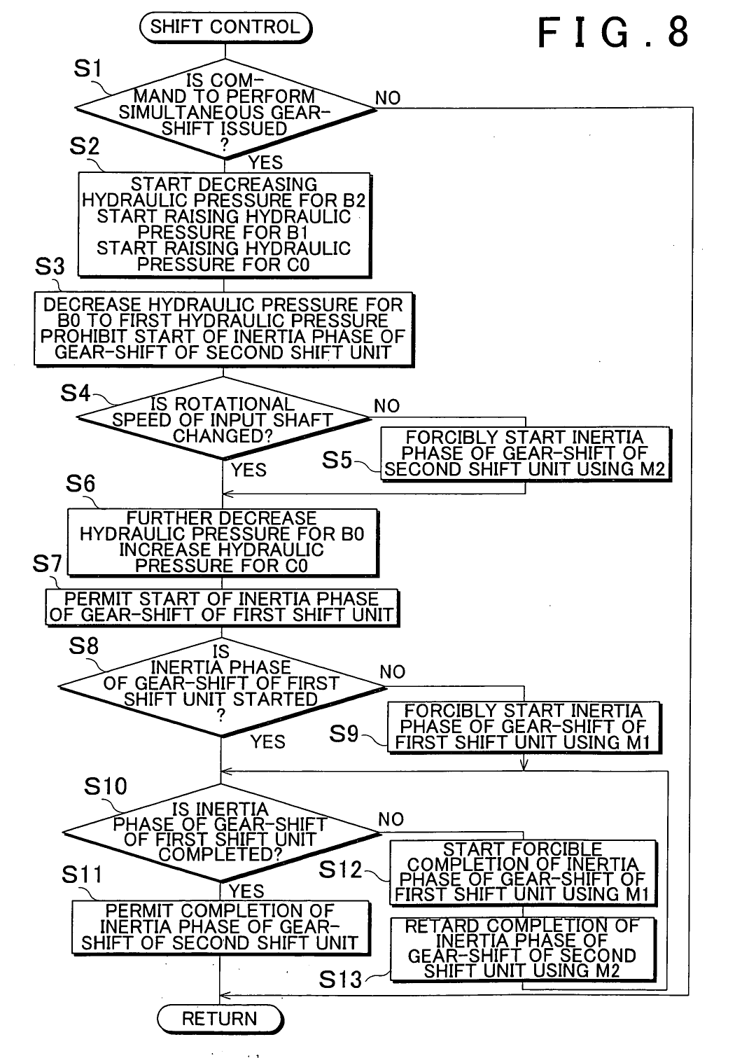

FIG. 8 is a flowchart showing the main portion of the control executed by the electronic control unit 40, that is, the shift control routine for controlling the simultaneous gear-shift in which the gear-shift of the first shift unit 16 and the gear-shift of the second shift unit 20 are performed at the same time. The routine shown in FIG. 8 is periodically executed at predetermined time intervals. FIG. 9 is a time chart showing the operation of each portion corresponding to the control routine shown in FIG. 8. Hereafter, description will be provided with reference to FIG. 8 and FIG. 9.

In step (hereinafter, simply referred to as “S”) 1 that corresponds to the operations of the simultaneous gear-shift determination unit 76 and the gear ratio change direction determination unit 78, it is determined whether a command to perform simultaneous gear-shift, in which the gear-shift of the first shift unit 16 and the gear-shift of the second shift unit 20 are performed at the same time and the gear ratio γ0 of the first shift unit 16 and the gear ratio γA of the second shift unit 20 change in the opposite directions, has been issued. If a negative determination is made in S1, the routine ends. On the other hand, if an affirmative determination is made in S1, S2 and the following steps are executed. The state at time t1 in FIG. 9 shows the state in which an affirmative determination is made in S1, that is, it is determined that a command to perform the simultaneous gear-shift has been issued. Description on the control executed in S2 and the following steps will be provided on the assumption that the gear-shift from second gear 2nd to third gear 3rd shown in FIG. 2 is performed in the transmission 30.

In S2, the gear-shift of the transmission 30 is started. That is, the control for decreasing the hydraulic pressure to release the second brake B2 is started and the control for raising the hydraulic pressure to apply the first brake B1 is started in the second shift unit 20. In addition, the control for raising the hydraulic pressure to apply the switching clutch C0 is started in the first shift unit 16 in order to maintain the favorable response of the gear-shift to the control. The state at time t2 in FIG. 9 shows the state in S2.

Next, in S3, the control for decreasing the hydraulic pressure that is supplied to the switching brake B0 to a predetermined first hydraulic pressure is executed over the first shift unit 16. The first hydraulic pressure is set in advance so that slippage of the switching brake B0 does not occur. In this case, the control is executed with the use of the first electric motor M1 so that the rotational speed of the sun gear S0 of the first shift unit 16 is brought to zero in order not to start the inertia phase of the gear-shift of the first shift unit 16.

Next, in S4, it is determined whether the rotational speed of the input shaft of the second shift unit 20 is changed by the gear-shift of the second shift unit 20. That is, it is determined whether the inertia phase of the gear-shift of the second shift unit 20 has been started. The state at time t3 in FIG. 9 shows the state in which an affirmative determination is made in S4. When a negative determination is made in S4 and an affirmative determination is not made within a predetermined period, the inertia phase of the gear-shift of the second shift unit 20 is forcibly started by controlling the rotation of the third rotating element RE3 of the second shift unit 20 with the use of the second electric motor M2 (by decreasing the speed of rotation input in the second shift unit 20). After S5 is completed, S6 and the following steps are executed. If an affirmative determination is made in S4, S6 and the following steps are executed after completion of S4. During a period from time t4 to time t7 shown in FIG. 9, the engine torque-down control for decreasing the output torque T_{E} from the engine 10 to a predetermined value.

In S6, the control for further decreasing the hydraulic pressure that is supplied to the switching brake B0 is executed and the control for increasing the hydraulic pressure that is supplied to the switching clutch C0 is executed. Thus, the gear-shift of the first shift unit 16 is actually started. Then, in S7, start of the inertia phase of the gear-shift of the first shift unit 16 is permitted. In other words, restriction on start of the inertia phase of the gear-shift of the first shift unit 16 is removed.

In S8, it is determined whether the inertia phase of the gear-shift of the first shift unit 16 has been started. If a negative determination is made in S8 and an affirmative determination is not made in S8 within a predetermined period, the inertia phase of the gear-shift of the first shift unit 16 is forcibly started by controlling the rotation of the second rotating element RE2 of the first shift unit 16 with the use of the first electric motor M1 (by increasing the rotational speed of the input shaft of the first shift unit 16). After completion of S9, S10 and the following steps are executed. On the other hand, if an affirmative determination is made in S8, S10 and the following steps are executed after completion of S8. The state at time t5 in FIG. 9 shows the state in which the inertia phase of the gear-shift of the first shift unit 16 is forcibly started in S9.

In S10, it is determined whether the inertia phase of the gear-shift of the first shift unit 16 has been completed. If an affirmative determination is made in S10, completion of the inertia phase of the gear-shift of the second shift unit 20 is permitted. In other words, the routine ends after restriction on completion of the inertia phase of the gear-shift of the second shift unit 20 is removed. The state at time t7 in FIG. 9 shows the state in which the inertia phase of the gear-shift of the second shift unit 20 has been completed in S11 and the gear-shift of the transmission 30 as a whole has been completed.

If a negative determination is made in S10, in S12, forcible completion of the inertia phase of the gear-shift of the first shift unit 16 is started by controlling the rotation of the second rotating element RE2 of the first shift unit 16 with the use of the first electric motor M1 (by increasing the speed of rotation input in the first shift unit 16). The state at time t6 in FIG. 9 shows the state in which the inertia phase of the gear-shift of the first shift unit 16 is forcibly completed in S12. Next, in S113, the rotation of the third rotating element RE3 is controlled with the use of the second electric motor M2 so that the inertia phase of the gear-shift of the second shift unit 20 is not completed, that is, completion of the inertia phase of the gear-shift of the second shift unit 20 is retarded. After completion of S13, S10 and the following steps are executed again. Preferably, the timing at which the pressure for applying the first brake B1 starts rising is retarded in S13.

S3 to S5 and S7 to S13 in the control routine correspond to the operation of the hybrid control unit 72, and S2, S3 and S6 in the control routine correspond to the operation of the stepped shift control unit 74. In the control from S1 to S113, the control is executed with the use of the first electric motor M1 so that the direction in which the rotational speed NE of the engine 10 is changed is maintained constant throughout the gear-shift. Thus, as shown in the period from time t2 to time t7 in FIG. 9, the rotational speed NE of the engine 10 is monotonously decreased throughout the gear-shift control shown in the flowchart in FIG. 8, and reversion of the direction in which the engine speed NE changes (the engine speed NE that has been decreasing starts increasing) is suppressed.

As described above, according to the first embodiment of the invention, the vehicle power transmission apparatus 8 includes the engine 10 that serves as a main drive power source, the first shift unit 16 that has the input shaft 14 connected to the engine 10, the second shift unit 20, and at least one electric motor M that is connected to the rotating element of the first shift unit 16 or the rotating element of the second shift unit 20 so that the rotational speed of the first electric motor M changes in accordance with the gear-shift of the first shift unit 16 or the gear-shift of the second shift unit 20, and the control unit. The rotational speed NE of the engine 10 is controlled by changing the rotation of the electric motor M. When the gear-shift of the first shift unit 16 and the gear-shift of the second shift unit 20 are performed at the same time and the gear ratio γ0 of the first shift unit 16 and the gear ratio γA of the second shift unit 20 change in the opposite directions, the control is executed with the use of the electric motor M so that the direction in which the rotational speed NE of the engine 10 is changed is maintained constant throughout the gear-shift. Therefore, it is possible to prevent fluctuations of the rotational speed NE of the engine 10, thereby shifting gears smoothly. That is, it is possible to provide the vehicle power transmission apparatus 8 with which occurrence of shift shock is effectively suppressed.

The rotation of the electric motor M is controlled based on a change in the speed of rotation input in the second shift unit 20, that is, a change in the rotational speed of the transmitting member 18 according to the predetermined relational diagrams. Therefore, it is possible to prevent fluctuations of the rotational speed NE of the engine 10 with the use of the electric motor M in a practical manner.

The first shift unit 16 includes the planetary gear unit 24 that has the first rotating element RE1 connected to the engine 10, the second rotating element. RE2 connected to the first electric motor M1, and the third rotating element RE3 connected to the transmitting member 18 that serves as an input member for the second shift unit 20. Therefore, in the power transmission apparatus 8 that includes the first shift unit 16 that has a practical configuration, it is possible to effectively suppress occurrence of shift shock in the simultaneous gear-shift of the first shift unit 16 and the second shift unit 20.

The characteristics of the first shift unit 16 and the second shift unit 20 are controlled with the use of the brakes B and the clutches C that are the hydraulic friction application devices, and the supplemental control is executed with the use of the electric motor M to maintain the characteristics. Therefore, it is possible to effectively suppress occurrence of shift shock in the transmission that is formed of the first shift unit 16 that has a practical configuration and the second shift unit 20.

The control is executed so that the inertia phase of the gear-shift of the first shift unit 16 is started and completed in the period from when the inertia phase of the gear-shift of the second shift unit 20 is started until when the inertia phase of the gear-shift of the second shift unit 20 is completed. Therefore, it is possible to effectively suppress occurrence of shift shock in a practical manner.

The first shift unit 16 is an electric shift unit that is placed in either the continuously variable shift mode in which the first shift unit 16 performs an electric continuously variable shift operation or the stepped shift mode in which the first shift unit 16 does not perform the continuously variable shift operation. Therefore, in the transmission that includes the first shift unit which serves as an electric shift unit, it is possible to effectively suppress occurrence of shift shock.

In addition, the shift mode of the first shift unit 16 is switched between the continuously variable shift mode and the stepped shift mode in the period from when the inertia phase of the gear-shift of the second shift unit 20 is started until when the inertia phase of the gear-shift of the second shift unit 20 is completed. Therefore, it is possible to effectively suppress occurrence of shift shock in a practical manner.

In addition, the torque-down control is executed over the engine 10 during a phase in which the rotational speed NE of the engine 10 is changed in accordance with at least one of the gear-shift of the first shift unit 16 and the gear-shift of the second shift unit 20. Accordingly, it is possible to suppress an abrupt change in the engine speed NE due to the gear-shift, thereby more smoothly shift gears.

The second shift unit 20 is a stepped shift unit that selects one of multiple gears in accordance with application/release states of the multiple friction application devices, that is, the brakes B and the clutches C. In the second shift unit 20, one of the multiple friction application devices is applied and another one of the multiple friction application devices is released, that is, a so-called clutch-to-clutch gear-shift is performed. Therefore, it is possible to effectively suppress occurrence of shift shock in the transmission 30 that includes the stepped shift unit which has a practical configuration.

Next, a second embodiment of the invention will be described. In the description below, the same reference numerals will be assigned to the portions that are the same as those in the first embodiment of the invention. The portions that are the same as those in the first embodiment of the invention will not be described below.

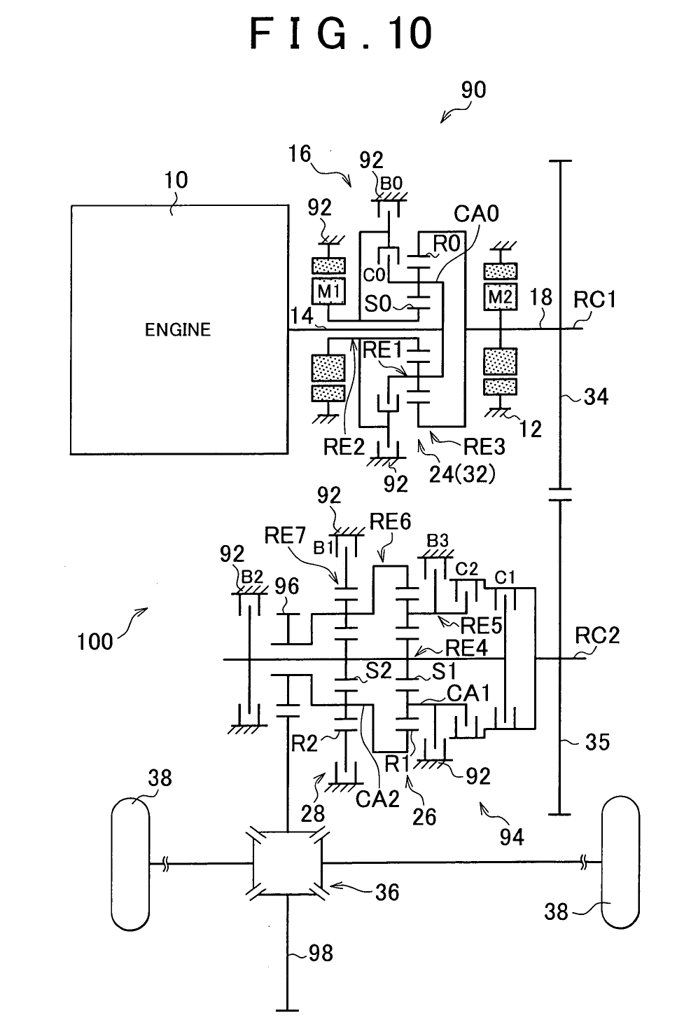

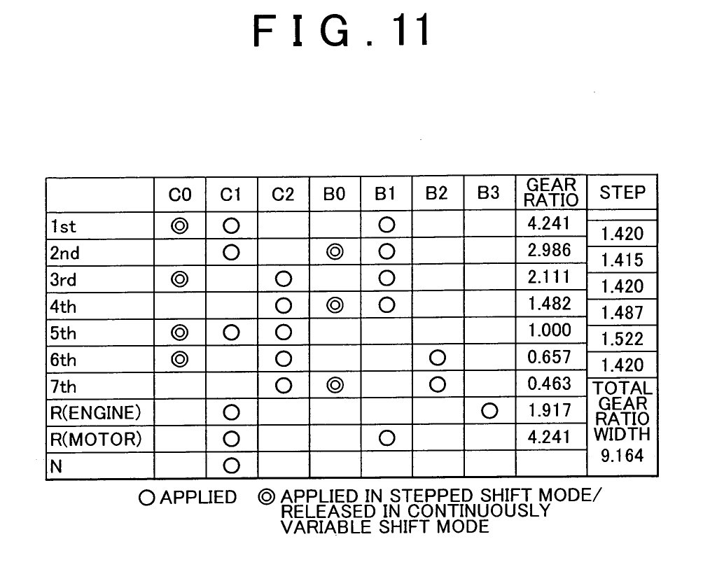

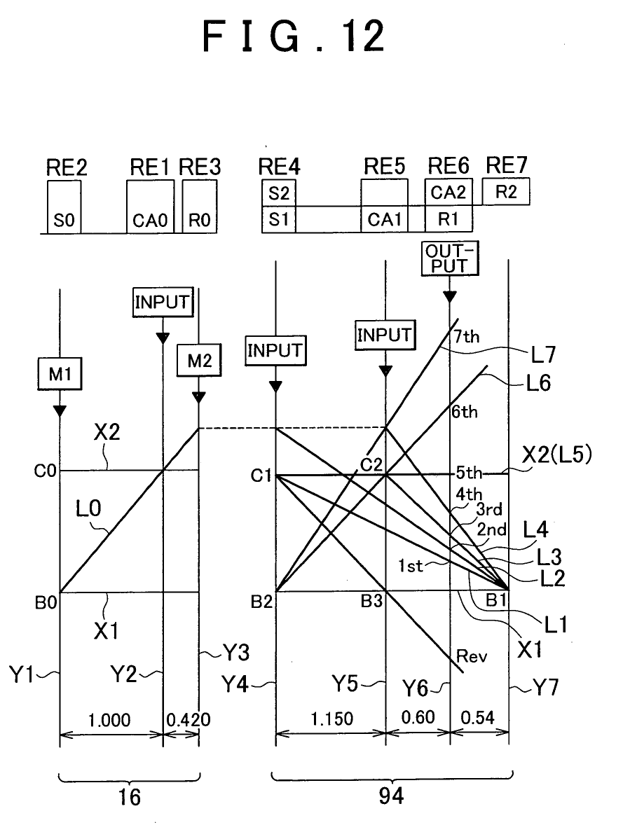

FIG. 10 is a view schematically showing the structure of a vehicle power transmission apparatus 90 according to the second embodiment of the invention. FIG. 11 is an operation chart showing the relationship between shift operations, which are performed when a transmission of the power transmission apparatus 90 in FIG. 10 is made to shift gears in a stepped manner, and the combinations of hydraulic friction application devices that are applied when the shift operations are performed. FIG. 12 is a collinear diagram illustrating the relative rotational speed in each gear when the transmission of the power transmission apparatus 90 in FIG. 10 is made to shift gears in a stepped manner.

As shown in FIG. 10, the power transmission apparatus 90 according to the second embodiment of the invention includes the first shift unit 16 which has the same structure as that in the first embodiment of the invention and in which the first electric motor M1, the power split mechanism 32 and the second electric motor M2 are all arranged on a first axis RC1, and a second shift unit 94, which serves as a forward four-speed stepped shift unit, arranged on a second axis RC2 parallel to the first axis RC1. This structure is employed in order to reduce the length of the power split mechanism 90 in its axial direction so that the power transmission apparatus 90 is housed in a transaxle case 92 (hereinafter, referred to as “case 92”) mounted in a FF (front-engine front-drive) vehicle. As in the first embodiment of the invention, the power split mechanism 32 shown in FIG. 10 includes the single-pinion planetary gear unit 24 that has a predetermined gear-ratio ρ1 of, for example, approximately 0.300, the switching clutch C0 and the switching brake B0. The second shift unit 94 includes the single-pinion first planetary gear unit 26 that has a predetermined gear ratio ρ2 of, for example, “0.522” and the single-pinion second planetary gear unit 28 that has a predetermined gear ratio ρ3 of, for example, approximately “0.309”. The first sun gear S1 of the first planetary gear unit 26 and the second sun gear S2 of the second planetary gear unit 28 are meshed with each other, and selectively connected to the transmitting member 18 via the first clutch C1, a pair of a counter a drive gear 34 and a counter driven gear 35 that are meshed with each other, and selectively connected to the case 92 via the second brake B2. Also, the first carrier CA1 of the first planetary gear unit 26 is selectively connected to the transmitting member 18 via the second clutch C2 and the pair of the counter drive gear 34 and the counter driven gear 35 that are meshed with each other, and selectively connected to the case 92 via the third brake B3. Also, the first ring gear R1 of the first planetary gear unit 26 and the second carrier CA2 of the second planetary gear unit 28 are connected to each other, and connected to an output gear 96 that serves as an output member. The second ring gear R2 of the second planetary gear unit 28 is selectively connected to the case 92 via the first brake B1. The output gear 96 is meshed with a differential drive gear 98 of the differential gear unit (final reduction device) 36, thereby transmitting power to the drive wheels 38 via a pair of axles, etc. The counter drive gear 34 and the counter driven gear 35 are provided on the first axis RC1 and the second axis RC2, respectively, and serve as connection devices that operatively connect the transmitting member 18 to the first clutch C1 and the second clutch C2.

In the thus structured power transmission apparatus 90, a transmission 100 is formed of the first shift unit 16 and the second shift unit 94. In the transmission 100, as shown in the operation chart in FIG. 11, one of first gear to seventh gear, reverse gear or neutral is selected by selectively applying the switching clutch C, the first clutch C1, the second clutch C2, the switching brake B0, the first brake B1, the second brake B2 and the third brake B3. Thus, the total gear ratio γT (=rotational speed N_{IN} of the input shaft 14/rotational speed N_{OUT} of the output gear (output member) 96) at each gear is achieved. As shown in FIG. 11, the ratios between the total gear ratios γ of the adjacent gears are substantially equal to each other. In the second embodiment of the invention, the power split mechanism 32 includes the switching clutch C0 and the switching brake B0. The shift mode of the first shift unit 16 is switched between the continuously variable shift mode in which the first shift unit 16 serves as a continuously variable shift unit and the fixed shift mode in which the first shift unit 16 serves as a multi-speed shift unit having a constant gear ratio. The first shift unit 16 is placed in the fixed shift mode by applying one of the switching clutch C0 and the switching brake B0. Accordingly, in the transmission 100, the first shift unit 16, which is placed in the fixed shift mode by applying one of the switching clutch C0 and the switching brake B0, and the second shift unit 94 forms the stepped shift mode in which the transmission 100 serves as a stepped transmission. The first shift unit 16, which is placed in the continuously variable shift mode by releasing both the switching clutch C0 and the switching brake B0, and the second shift unit 94 forms the continuously variable shift mode in which the transmission 100 serves as an electric continuously variable transmission.

When the transmission 100 serves as a stepped transmission, one of the gears shown in FIG. 11 is selected. First gear having the maximum gear ratio γT1 of, for example, approximately 4.241 is selected by applying the switching clutch C0, the first clutch C1, and the first brake B1. Second gear having the gear ratio γT2 of; for example, approximately 2.986 which is smaller than the gear ratio γT1 of first gear is selected by applying the switching brake B0, the first clutch C1 and the first brake B1. Third gear having the gear ratio γT3 of, for example, approximately 2.111 which is smaller than the gear ratio γT2 of second gear is selected by applying the switching clutch C0, the second clutch C2 and the first brake B1. Fourth gear having the gear ratio γT4 of, for example, approximately 1.482 which is smaller than the gear ratio γT3 of third gear is selected by applying the switching brake B0, the second clutch C2 and the first brake B1. Fifth gear having the gear ratio γT5 of, for example, approximately 1.000 which is smaller than the gear ratio γT4 of fourth gear is selected by applying the switching clutch C0, the first clutch C1 and the second clutch C2. Sixth gear having the gear ratio γT6 of, for example, approximately 0.657 which is smaller than the gear ratio γT5 of fifth gear is selected by applying the switching clutch C0, the second clutch C2 and the second brake B2. Seventh gear having the gear ratio γT7 of, for example, approximately 0.463 which is smaller than the gear ratio γT6 of sixth gear is selected by applying the switching brake B0, the second clutch C2 and the second brake B2. When the vehicle is driven by the drive power from the engine 10, reverse gear having the gear ratio γR of, for example, approximately 1.917, which is a value between the gear ratio γT3 of third gear and the gear ratio γT4 of fourth gear, is selected by applying the first clutch C1 and the third brake B3. When the vehicle is driven by the drive power from the motor, reverse gear having the gear ratio γR of, for example, approximately 4.241, which is equal to the gear ratio γT1 of first gear, is selected by applying the first clutch C1 and the first brake B1. Neutral is selected by applying, for example, only the first clutch C1.

On the other hand, when the transmission 100 functions as a continuously variable transmission, both the switching clutch C0 and the switching brake B0 are released. As a result, the first shift unit 16 functions as a continuously variable shift unit. The second shift unit 94 that is connected in tandem with the first shift unit 16 functions as a forward four-speed stepped shift unit. The rotational speed of the transmitting member 18, that is, the speed of rotation input to the second shift unit 94, which is at one of first gear of the second shift unit 94, second gear of the second shift unit 94, third gear of the second shift unit 94, and fourth gear of the second shift unit 94, is continuously changed so that gear ratio of each gear is allowed to change continuously. Accordingly, the gears are shifted while the gear ratio is continuously changed. As a result, the transmission 100 as a whole is placed in the continuously variable shift mode, and the total gear ratio γT, which is achieved by the transmission 100 as a while, is continuously changed.

FIG. 12 is a collinear diagram that shows, using straight lines, the correlative relationships among the rotational speeds of the various rotating elements of the transmission 100 that is formed of the first shift unit 16 that functions as a continuously variable shift unit or a differential unit and the second shift unit 94 that functions as a stepped automatic shift unit. The connection states of the rotating elements vary depending on the selected gear. The rotational speed of each element of the power split mechanism 32 when both the switching clutch C0 and the switching brake B0 are released and the rotational speed of each element of the power split mechanism 32 when the switching clutch C0 or the switching brake B0 is applied are as described above.

Four vertical lines Y4, Y5, Y6 and Y7 for the second shift unit 94 in FIG. 12 represent, in order from left to right, the relative rotational speeds of the first sun gear S1 and the second sun gear S2 that are regarded as a fourth rotating element RE4 and that are connected to each other, the first carrier CA1 that is regarded as a fifth rotating element RE5, the second carrier CA2 and the first ring gear R1 that are regarded as a sixth rotating element RE6 and that are connected to each other, and the second ring gear R2 that is regarded as a seventh rotating element RE7. In the second shift unit 94, the fourth rotating element RE4 is selectively connected to the transmitting member 18 via the first clutch C1, and selectively connected to the case 92 via the second brake B2. The fifth rotating element RE5 is selectively connected to the transmitting member 18 via the second clutch C2, and selectively connected to the case 92 via the third brake B3. The sixth rotating element RE6 is connected to the output gear 96 of the second shift unit 94, and selectively connected to the case 92 via the first brake B1.

As shown in FIG. 12, in the second shift unit 94, when the switching clutch C0, the first clutch C1 and the first brake B1 are applied, first gear is selected. As illustrated in FIG. 12, the rotational speed of the output gear 96 in first gear is represented by the point of intersection of i) a sloped straight line L1 that passes through both the point of intersection of a horizontal line X1 and the vertical line Y7 which represents the rotational speed of the seventh rotating element RE7 (R2) and the point of intersection of a horizontal line X2 and the vertical line Y4 which represents the rotational speed of the fourth rotating element RE4 (S1, S2), and ii) the vertical line Y6 that represents the rotational speed of the sixth rotating element RE6 (R1, CA2) which is connected to the output gear 96. When the switching brake B0, the first clutch C1 and the first brake B1 are applied, second gear is selected. The rotational speed of the output gear 96 in second gear is represented by the point of intersection of a sloped straight line L2, which is defined by application of the switching brake B0, the first clutch C1 and the first brake B1, and the vertical line Y6 that represents the rotational speed of the sixth rotating element RE6 which is connected to the output gear 96. When the switching clutch C0, the second clutch C2 and the first brake B1 are applied, third gear is selected. The rotational speed of the output gear 96 in third gear is represented by the point of intersection of a sloped straight line L3, which is defined by application of the switching clutch C0, the second clutch C2 and the first brake B1, and the vertical line Y6 that represents the rotational speed of the sixth rotating element RE6 which is connected to the output gear 96. When the switching brake B0, the second clutch C2 and the first brake B1 are applied, fourth gear is selected. The rotational speed of the output gear 96 in fourth gear is represented by the point of intersection of a sloped straight line L4, which is defined by application of the switching brake B0, the second clutch C2 and the first brake B1, and the vertical line Y6 that represents the rotational speed of the sixth rotating element RE6 which is connected to the output gear 96. When the switching clutch C0, the first clutch C1 and the second clutch C2 are applied, fifth gear is selected. The rotational speed of the output gear 96 in fifth gear is represented by the point of intersection of a sloped straight line L5, which is defined by application of the switching clutch C0, the first clutch C1 and the second clutch C2, and the vertical line Y6 that represents the rotational speed of the sixth rotating element RE6 which is connected to the output gear 96. When the switching clutch C0, the second clutch C2 and the second brake B2 are applied, sixth gear is selected. The rotational speed of the output gear 96 in sixth gear is represented by the point of intersection of a sloped straight line L6, which is defined by application of the switching clutch C0, the second clutch C2 and the second brake B2, and the vertical line Y6 that represents the rotational speed of the sixth rotating element RE6 which is connected to the output gear 96. When the switching brake B0, the second clutch C2 and the second brake B2 are applied, seventh gear is selected. The rotational speed of the output gear 96 in seventh gear is represented by the point of intersection of a sloped straight line L7, which is defined by application of the switching brake B0, the second clutch C2 and the second brake B2, and the vertical line Y7 that represents the rotational speed of the sixth rotating element RE6 which is connected to the output gear 96.

In the thus structured power transmission apparatus 90 (transmission 100) according to the second embodiment of the invention, as shown in FIG. 11, forward seven gears are set in order to reduce the difference between the gear ratios of the adjacent gears (close-ratio) and increase the gear ratio width (gear ratio of the lowest gear/gear ratio of the highest gear). Accordingly, as described above, the gear-shift of the first shift unit 16 and the gear-shift of the second shift unit 94 may be performed at the same time, and the gear ratio γ0 of the first shift unit 16 and the gear ratio γA of the second shift unit 20 may change in the opposite directions. Therefore, as in the first embodiment of the invention, the engine speed NE may be increased by downshifting of one of the first shift unit 16 and the second shift unit 94, engine speed NE may be increased by upshifting of the other of the first shift unit 16 and the second shift unit 94. Therefore, if the timing of the gear-shift of the first shift unit 16 and the timing of the gear-shift of the second shift unit 20 are slightly off, the engine speed NE fluctuates, which may give a sense of discomfort to the occupants. In order to prevent occurrence of such inconvenience, the control function described above with reference to FIG. 5 is applied. When the gear-shift of the first shift unit 16 and the gear-shift of the second shift unit 94 are performed at the same time and the gear ratio γ0 of the first shift unit 16 and the gear ratio γA of the second shift unit change in the opposite directions, the control is executed with the use of the electric motor M so that the direction in which the rotational speed NE of the engine 10 is changed is maintained constant throughout the gear-shift. In this way, it is possible to suppress occurrence of shift shock.

According to the second embodiment of the invention, the power split mechanism 32 and the second shift unit 94 are not provided on the same axis, unlike the power transmission apparatus 8 in FIG. 1. Therefore, the length of the transmission 100 in its axial direction is further reduced. Accordingly, the transmission 100 is used preferably in a FF vehicle and a RR vehicle in which the length of a transmission in the axial direction of the transmission is restricted by the vehicle width, because the transmission 100 can be disposed transversely, that is, the transmission 100 can be disposed in such a manner that the first axis RC1 and the second axis RC2 extend in the vehicle width direction. In addition, because the power split mechanism 32 and the second shift unit 94 are arranged between the engine 10 (differential drive gear 32) and the pair of the counter gears, the length of the transmission 100 in its axial direction is further reduced. Further, because the second electric motor M2 is arranged on the first axis RC1, the length of the second axis RC2 is reduced.

While the embodiments of the invention have been described with reference to the accompanying drawings, the invention may be implemented in various other embodiments.

For example, in the embodiments of the invention described with reference to the flowchart in FIG. 8 and the time chart in FIG. 9, the control according to the invention is applied to gear-shift from second gear 2nd to third gear 3rd, that is upshifting. However, the application of the invention is not limited to upshifting. The invention may be applied to downshifting. For example, the gear-shift from third gear 3rd to second gear 2nd and gear-shift from gear 5th to fourth gear 4th each correspond to a simultaneous gear-shift in which the gear ratio γ0 of the first shift unit 16 decreases while the gear ratio γA of the second shift unit 20 increases. Therefore, it is possible to effectively suppress occurrence of shift shock by applying the invention.

In the embodiments of the invention described above, the invention is applied to the transmission 30 that includes the first shift unit 16 and the second shift unit 20 and the transmission 100 that includes the first shift unit 16 and the second shift unit 94, the second shift units 20 and 94 being stepped transmissions. However, application of the invention is not limited to the transmission that includes the first shift unit and the second shift unit. The invention may be applied to vehicle power transmission apparatuses that include a first shift unit, a second shift unit, and at least one electric motor that is connected to a rotating element of the first shift unit or an rotating element of the second shift unit so that the rotational speed of the electric motor changes in accordance with the gear-shift of the first shift unit or the gear-shift of the second shift unit.

In the power split mechanism 32 according to the embodiments of the invention, the carrier CA1 is connected to the engine 10, the first sun gear S0 is connected to the first electric motor M1, and the ring gear R0 is connected to the transmitting member 18. However, the manner in which these elements are connected to each other is not limited to this. Each of the engine 10, the first electric motor M1, and the transmitting member 18 may be connected to any one of the three elements CA1, S0 and R0 of the first planetary gear unit 24.

In the embodiments of the invention described above, the engine 10 is directly connected to the input shaft 14. Alternatively, the engine 10 may be operatively connected to the input shaft 14 via, for example, a gear, a transmission chain, or a transmission belt. Further, the engine 10 and the input shaft 14 need not be provided on the same axis. In the second embodiment of the invention in FIG. 10, a pair of sprockets around which a transmission chain is wound may be provided instead of the counter drive gear 34 and the counter driven gear 35.

The hydraulic friction application devices in the embodiments of the invention described above such as the switching clutches C0 and the switching brakes B0 may be formed of powder application devices such as powder clutches, electromagnetically-controlled application devices such as electromagnetically-controlled clutches or mechanical application devices such as mesh-type dog clutches.

In the embodiments of the invention described above, the second electric motor M2 is connected to the transmitting member 18. Alternatively, the second electric motor M2 may be connected to the output shaft 22. Further alternatively, the second electric motor M2 may be connected to a rotating member in the second shift unit 20 or 94.

The power split mechanism 32 that serves as a differential mechanism in the embodiments of the invention described above may be a differential gear unit that includes pinions which are rotated by the engine 10 and a pair of bevel gears that are in mesh with the pinions and that are operatively connected to the first electric motor M1 and the second electric motor M2.

The power split mechanism 32 in the embodiments of the invention is formed of one set of planetary gear unit. Alternatively, the power split mechanism 32 may be formed of two or more sets of planetary gear units, and function as three or more speed gear-shift unit in the non-differential mode (fixed shift mode).

The invention may be implemented in various other embodiments within the scope of the invention.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are example, other combinations and configurations, including more, less or only a single elements, are also within the scope of the invention.

What is claimed is:

1. A power transmission apparatus for a vehicle, comprising:
a main drive power source;
a first shift unit that has an input shaft connected to the main drive power source;
a second shift unit;
at least one electric motor that is connected to a rotating element of the first shift unit or a rotating element of the second shift unit so that a rotational speed of the electric motor is changed in accordance with a gear-shift of the first shift unit or a gear-shift of the second shift unit, and that controls a rotational speed of the main drive power source by changing rotation of the electric motor; and
a control unit that executes control so that a direction in which the rotational speed of the main drive power source is changed is maintained constant throughout a gear-shift, when the gear-shift is a simultaneous gear-shift in which the gear-shift of the first shift unit and the gear-shift of the second shift unit are performed simultaneously and a gear ratio of the first shift unit and a gear ratio of the second shift unit are changed in opposite directions.

2. The power transmission apparatus according to claim 1, wherein the control unit controls the rotation of the electric motor based on a change in a speed of rotation input in the second shift unit according to a predetermined relationship.

3. The power transmission apparatus according to claim 2, wherein the first shift unit has a planetary gear unit that includes a first rotating element connected to the main drive power source, a second rotating element connected to the electric motor, and a third rotating element connected to an input member of the second shift unit.

4. The power transmission apparatus according to claim 1, wherein the first shift unit has a planetary gear unit that includes a first rotating element connected to the main drive power source, a second rotating element connected to the electric motor, and a third rotating element connected to an input member of the second shift unit.
